(19) United States
(12) Patent Application Publication
(10) Pub. No.: US 2015/0234907 A1
(43) Pub. Date: Aug. 20, 2015

(54) TEST ENVIRONMENT MANAGEMENT APPARATUS AND TEST ENVIRONMENT CONSTRUCTION METHOD

(71) Applicant: Hitachi, Ltd., Tokyo (JP)

(72) Inventors: Daisuke Shinohara, Tokyo (JP); Yukinori Sakashita, Tokyo (JP)

(73) Assignee: Hitachi, Ltd., Tokyo (JP)

(21) Appl. No.: 14/353,431

(22) PCT Filed: Mar. 29, 2013
(86) PCT No.: PCT/JP2013/059542

§ 371 Date: Apr. 22, 2014

(51) Int. Cl. G06F 17/30

(52) U.S. Cl. CPC G06F 17/30575

(57) ABSTRACT

Proposed are a test environment management apparatus and a test environment construction method capable of swiftly constructing a test environment of an integrated system.

In a test environment management apparatus that is connected to an integrated system of a replication source and an integrated system of a replication destination, respectively, the test environment management apparatus comprises a storage unit that stores configuration information of a server apparatus, a storage apparatus and a network apparatus configuring the replication source integrated system and the replication destination integrated system, respectively, as configuration information of a replication source and configuration information of a replication destination, and a test environment replication unit that replicates a test environment, which was constructed in the replication source integrated system, in the replication destination integrated system by referring to the configuration information of the replication source and the configuration information of the replication destination.

### TECHNICAL FIELD

The present invention relates to a test environment management apparatus and a test environment construction method, and in particular relates to a test environment management apparatus and a test environment construction method capable of constructing a test environment by replicating an integrated system configured from a server apparatus, a storage apparatus and a network apparatus.

### BACKGROUND ART

In recent years, the commercialization of an integrated system which integrates a server apparatus, a storage apparatus and a network apparatus as one system is being promoted. An integrated system is generally delivered to the customer company after the supplier company conducts various verifications, including development of applications in advance, so that the performance of the server apparatus, the storage apparatus and the network apparatus configuring the integrated system is optimized.

Thus, there are advantages for the customer company in that the troubles of conducting the various verifications can be omitted, and the system can be deployed faster than having the server apparatus, the storage apparatus and the network apparatus individually delivered. Based on the popularization of the integrated system, it is anticipated that data centers installed with a plurality of integrated systems will appear in the future.

Incidentally, NPL 1 discloses a technology of constructing a test environment in a virtual machine of one server apparatus, and constructing a test environment in another server apparatus by replicating the foregoing test environment, as a template, in the server apparatus (virtual machine). When the supplier company is to conduct various verifications in advance, for example, by using the technology of NPL 1, NPL 1 describes that it is possible to respectively virtualize the server apparatus, the storage apparatus and the network apparatus and construct a test environment, prepare this as a template in advance, and construct a test environment in another integrated system by replicating the test environment in the other integrated system.

### CITATION LIST

### NPL

[NPL 1]

Using Clones to Streamline Development (http://www.vmware.com/pdf/ws5_clones_tech note.pdf)

### SUMMARY OF INVENTION

### Technical Problem

Nevertheless, when a test environment is to be created using the technology described in NPL 1, in the test environment of the replication destination, the identifying information of the storage apparatus (logical volume) to be accessed by the application in the server apparatus (virtual machine) must be set according to the test environment of the replication destination. Moreover, the network apparatus (logical port and logical host bus adapter) for communicably connecting the server apparatus (virtual machine) and the storage apparatus (logical volume) must similarly be set according to the test environment of the replication destination. In addition, the network apparatus (logical NIC) for connecting to the test environment of the replication destination from the outside must similarly be set according to the test environment of the replication destination.

In other words, even if a test environment is created using the technology described in NPL 1, each of the various settings described above must be set individually in the replication destination. Moreover, since the related settings must be changed exhaustively pursuant to the individual settings, there is a possibility that an erroneous setting or an erroneous operation may occur. Accordingly, even if the technology described in NPL 1 is adopted, the test environment of the integrated system cannot be constructed swiftly.

The present invention was devised in consideration of the foregoing points, and an object of this invention is to propose a test environment management apparatus and a test environment construction method capable of swiftly constructing a test environment of an integrated system.

### Solution to Problem

In order to achieve the foregoing object, the test environment management apparatus of the present invention is connected to an integrated system of a replication source and an integrated system of a replication destination, respectively, and comprises a storage unit that stores configuration information of a server apparatus, a storage apparatus and a network apparatus configuring the replication source integrated system and the replication destination integrated system, respectively, as configuration information of a replication source and configuration information of a replication destination, and a test environment replication unit that replicates a test environment, which was constructed in the replication source integrated system, in the replication destination integrated system by referring to the configuration information of the replication source and the configuration information of the replication destination, wherein the test environment replication unit creates, in a storage apparatus of the replication destination, a logical volume having a configuration that is the same as a configuration of a logical volume allocated in a storage apparatus of the replication source, assigns, to each logical volume, a replication port for connecting a logical volume of the replication source and a logical volume of the replication destination, sets the replication port to go online, and replicates data, which is stored in the replication source logical volume, in the replication destination logical volume, cancels the assignment of the replication port by changing the setting of the replication port from online to offline, thereafter sets identifying information of the replication destination logical volume so that identifying information of the replication source logical volume and identifying information of the replication destination logical volume coincide, creates, in the replication destination storage apparatus, a logical port having a configuration that is the same as a configuration of a logical port of the replication source, and assigns the created logical port of the replication destination to the replication destination logical volume, creates, in a server apparatus of the replication destination, a logical configuration having a configuration that is the same as a logical configuration allocated in a server apparatus of the replication source, and sets, in the replication destination integrated system, an internal address that is the same as an internal address set in the replication source integrated system and an external address that is different from an external address set in the replication source integrated system.

Moreover, in order to achieve the foregoing object, the test environment construction method of the present invention is a test environment construction method of a test environment management apparatus that is connected to an integrated system of a replication source and an integrated system of a replication destination, respectively, the test environment management apparatus comprising a storage unit that stores configuration information of a server apparatus, a storage apparatus and a network apparatus configuring the replication source integrated system and the replication destination integrated system, respectively, as configuration information of a replication source and configuration information of a replication destination, and a test environment replication unit that replicates a test environment, which was constructed in the replication source integrated system, in the replication destination integrated system by referring to the configuration information of the replication source and the configuration information of the replication destination, wherein the test environment replication unit comprises a first step of creating, in a storage apparatus of the replication destination, a logical volume having a configuration that is the same as a configuration of a logical volume allocated in a storage apparatus of the replication source, a second step of assigning, to each logical volume, a replication port for connecting a logical volume of the replication source and a logical volume of the replication destination, setting the replication port to go online, and replicating data, which is stored in the replication source logical volume, in the replication destination logical volume, a third step of cancelling the assignment of the replication port by changing the setting of the replication port from online to offline, thereafter setting identifying information of the replication destination logical volume so that identifying information of the replication source logical volume and identifying information of the replication destination logical volume coincide, a fourth step of creating, in the replication destination storage apparatus, a logical port having a configuration that is the same as a configuration of a logical port of the replication source, and assigning the created logical port of the replication destination to the replication destination logical volume, a fifth step of creating, in a server apparatus of the replication destination, a logical configuration having a configuration that is the same as a logical configuration allocated in a server apparatus of the replication source, and a sixth step of setting, in the replication destination integrated system, an internal address that is the same as an internal address set in the replication source integrated system and an external address that is different from an external address set in the replication source integrated system.

### Advantageous Effects of Invention

According to the present invention, a test environment of an integrated system can be constructed swiftly.

### BRIEF DESCRIPTION OF DRAWINGS

FIG. 1 is an overall configuration diagram of the test execution system according to this embodiment.

FIG. 2 is an overall configuration diagram of the computer system.

FIG. 3 is an internal configuration diagram of the server apparatus.

FIG. 4 is an internal configuration diagram of the virtual machine.

FIG. 5 is an internal configuration diagram of the storage apparatus.

FIG. 6 is an internal configuration diagram of the operation-side switch.

FIG. 7 is an internal configuration diagram of the management computer.

FIG. 8 is an internal configuration diagram of the test computer.

FIG. 9 is a logical configuration diagram of the management program information.

FIG. 10 is a logical configuration diagram of the VM configuration definition information.

FIG. 11 is a logical configuration diagram of the external address assignment information.

FIG. 12 is a conceptual diagram of the physical HBA information included in the server configuration information.

FIG. 13 is a conceptual diagram of the logical HBA information included in the server configuration information.

FIG. 14 is a conceptual diagram of the physical NIC information included in the server configuration information.

FIG. 15 is a conceptual diagram of the logical NIC information included in the server configuration information.

FIG. 16 is a conceptual diagram of the physical port information included in the storage configuration information.

FIG. 17 is a conceptual diagram of the logical port information included in the storage configuration information.

FIG. 18 is a conceptual diagram of the logical volume information included in the storage configuration information.

FIG. 19 is a conceptual diagram of the path information included in the storage configuration information.

FIG. 20 is a conceptual diagram of the address mapping information included in the network configuration information.

FIG. 21 is a conceptual diagram of the communication control information included in the network configuration information.

FIG. 22 is a flowchart of the test environment construction processing.

FIG. 23 is an overall configuration diagram of the test execution system according to the second embodiment.

FIG. 24 is an internal configuration diagram of the computer system.

FIG. 25 is an internal configuration diagram of the storage apparatus.

FIG. 26 is an internal configuration diagram of the management computer.

FIG. 27 is a conceptual diagram of the physical port information included in the logical storage configuration information.

FIG. 28 is a conceptual diagram of the logical port information included in the logical storage configuration information.

FIG. 29 is a conceptual diagram of the logical volume information included in the logical storage configuration information.

FIG. 30 is a conceptual diagram of the path information included in the logical storage configuration information.

FIG. 31 is an internal configuration diagram of the management computer according to the third embodiment.

FIG. 32 is a screen configuration diagram of the volume selection screen.

FIG. 33 is a flowchart of the test environment construction processing.

### DESCRIPTION OF EMBODIMENTS

An embodiment of the present invention is now explained in detail with reference to the drawings.

### (1) First Embodiment

### (1-1) Overall Configuration

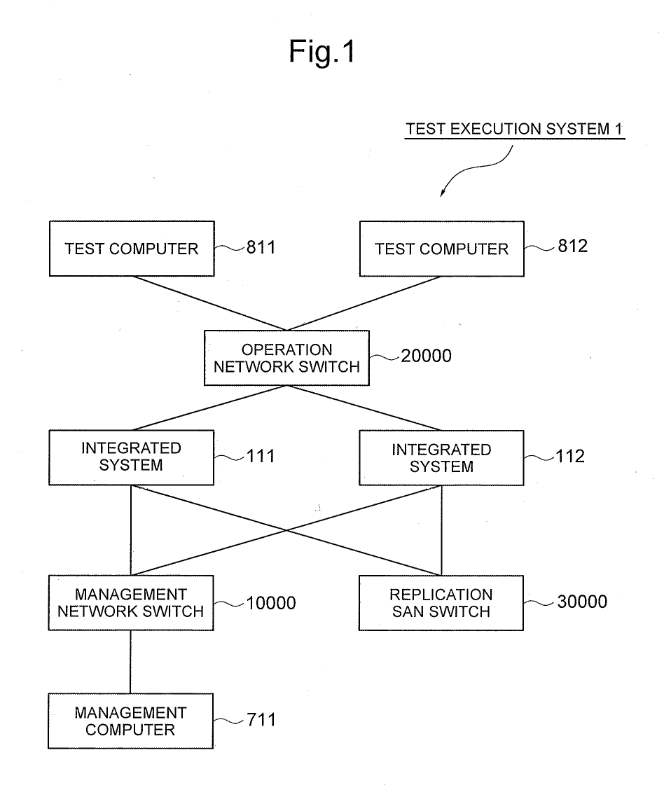

FIG. 1 shows the overall configuration of the test execution system 1 in the first embodiment. The test execution system is configured from a plurality of test computers 811, 812, an operation network switch 20000 for connecting to an operation-side network, a plurality of integrated systems 111, 112, a management network switch 10000 for connecting to a management-side network, a replication SAN switch 30000, and a management computer 711.

In addition, the plurality of test computers 811 and 812 and the plurality of integrated systems 111 and 112 are mutually connected communicably via the operation network switch 20000. Moreover, the plurality of integrated systems 111 and 112 and the management computer 711 are mutually connected communicably via the management network switch 10000. Moreover, the integrated system 111 and the integrated system 112 are mutually connected communicably via the replication SAN switch 30000.

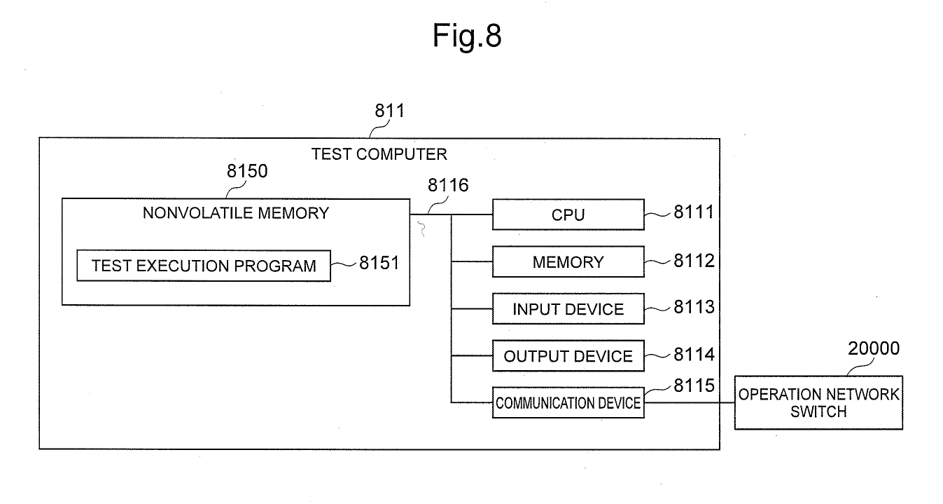

The test computer 811 conducts various verifications by connecting to the integrated system 111 or 112 via the operation network switch 20000. For example, the test computer 811 is a computer installed in a web application development base that executes a test tool to the integrated system 112, and verifies operations of the web application. The internal configuration of the test computer 811 will be explained later (FIG. 8).

As with the test computer 811, the test computer 812 also conducts various verifications by connecting to the integrated system 111 or 112. For example, the test computer 812 is a computer installed in a database application development base, executes a test tool to the integrated system 112, and verifies operations of the database application.

The integrated system 111 is one computer system which integrates a server apparatus, a storage apparatus and a network apparatus. Moreover, the integrated system 112 is a system that is created by replicating the integrated system 111, and is similarly one computer system which integrates a server apparatus, a storage apparatus and a network apparatus.

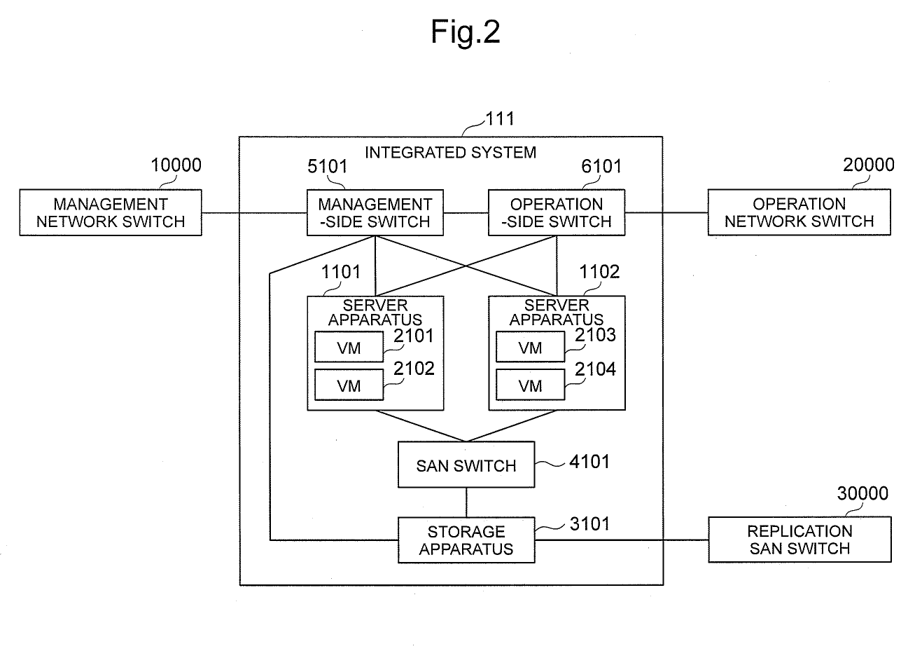

Note that, in this embodiment, a test environment, which is pre-constructed in the integrated system 11, is constructed in the integrated system 112 by replicating, in the integrated system 112, the various configurations of the integrated system 111. Accordingly, the integrated system 111 is sometimes explained as a replication source, and the integrated system 112 is sometimes explained as a replication destination. The internal configuration of the integrated systems 111 and 112 will be described later (FIG. 2 to FIG. 6).

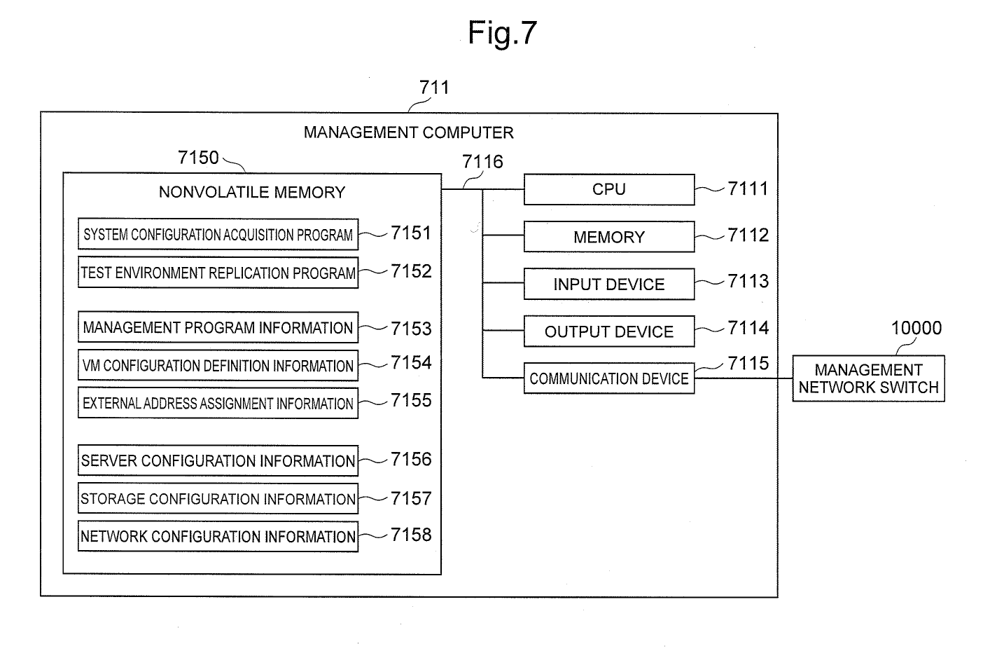

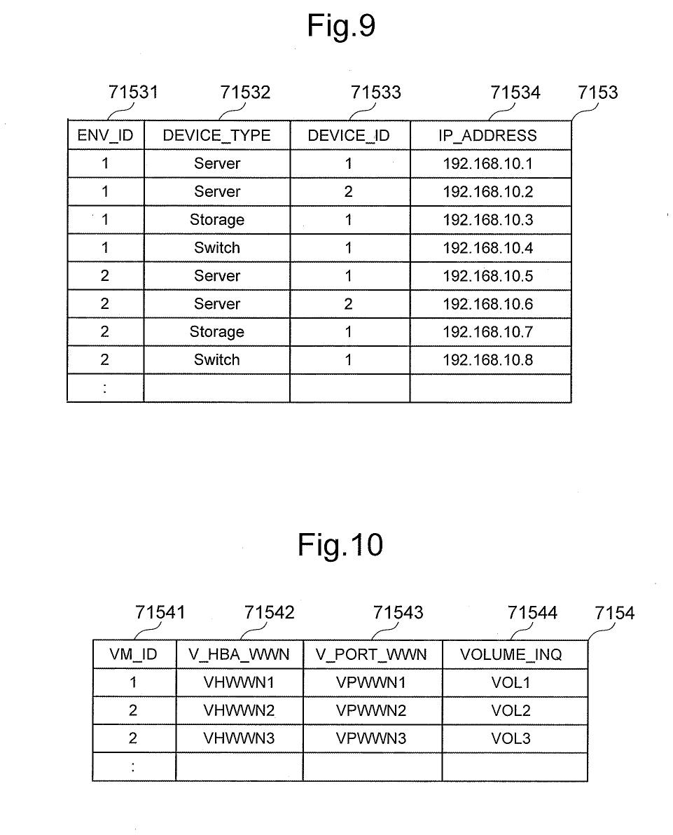

The management computer 711 acquires and manages various types of configuration information of the server apparatus, the storage apparatus and the network apparatus configuring the integrated systems 111 and 112, respectively, via the management network switch 10000. In addition, the management computer 711 replicates, for example, the test environment of the integrated system 111 in the integrated system 112 based on the various types of configuration information which it is managing. The internal configuration of the management computer 711, the various types of configuration information managed by the management computer 711, and the test environment replication processing to be executed by referring to the various types of configuration information will be explained later (FIG. 7, FIG. 9 to FIG. 22).

### (1-2) Internal Configuration

FIG. 2 shows the internal configuration of the integrated system 111. The integrated system 111 is configured from a management-side switch 5101, an operation-side switch 6101, a plurality of server apparatus 1101, 1102, a SAN switch 4101 and a storage apparatus 3101.

The management-side switch 5101 is a switch for mutually and communicably connecting the management network switch 10000, and the plurality of server apparatus 1101, 1102 and the storage apparatus 3101. The management computer 711 can acquire the various types of configuration information of the integrated system 111 via the management-side switch 5101.

The operation-side switch 6101 is a switch for mutually and communicably connecting the operation network switch 20000, and the management-side switch 5101 and the plurality of server apparatuses 1101 and 1102. The test computer 811 or 812 can execute a test tool to the integrated system 111 and verify the operation of various applications via the operation-side switch 6101.

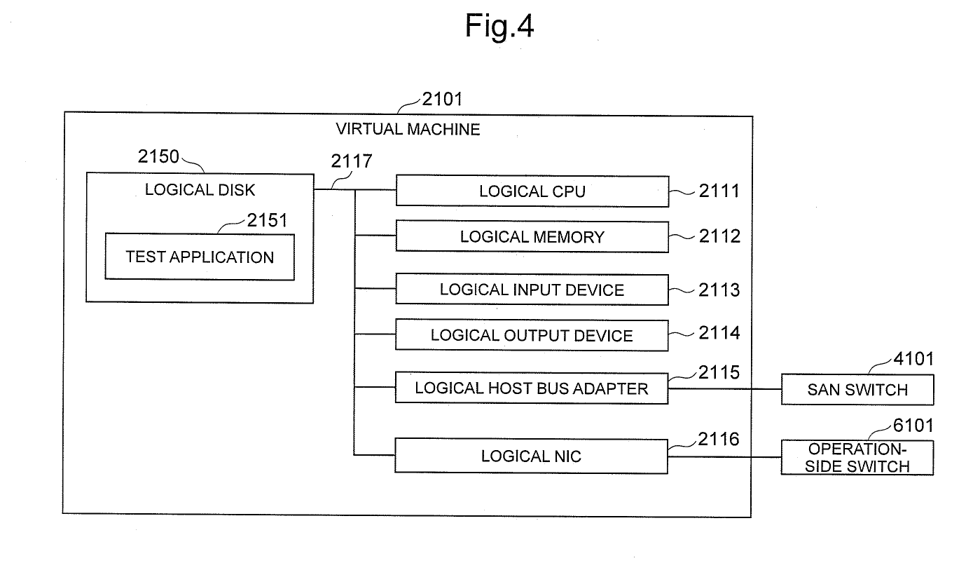

The server apparatus 1101 is configured by a plurality of virtual machines (VM: Virtual Machines) 2101 and 2102 being allocated therein. Moreover, the server apparatus 1102 is similarly configured by a plurality of VMs 2103 and 2104 being allocated therein. The server apparatuses 1101 and 1102 acquire, from the storage apparatus 3010, the image files of the virtual machines corresponding to the virtual machines 2102 to 2104 via the SAN switch 4101, and thereby execute the respective virtual machines 2102 to 2104. The internal configuration of these virtual machines will be explained later (FIG. 4).

The SAN switch 4101 is a switch for mutually and communicably connecting the server apparatuses 1101 and 1102 and the storage apparatus 3101 via the SAN (Storage Area Network).

The storage apparatus 3101 is configured by comprising a plurality of physical disks not shown, and configured by a plurality of logical volumes being allocated in a storage area provided by the plurality of physical disks. Each of the plurality of logical volumes stores, for example, an image file of the virtual machines corresponding to the virtual machines 2101 to 2104.

The replication SAN switch 30000 is a switch for mutually and communicably connecting the storage apparatus 3101 of the replication source and the storage apparatus of the integrated system 112 of the replication destination. The management computer 711 can replicate, in the storage apparatus of the integrated system 112 of the replication destination, data stored in the storage apparatus 3101 via the replication SAN switch 30000.

Since the internal configuration of the integrated system 112 of the replication destination is similar to the configuration of the integrated system 111 of the replication source described above, the explanation thereof is omitted.

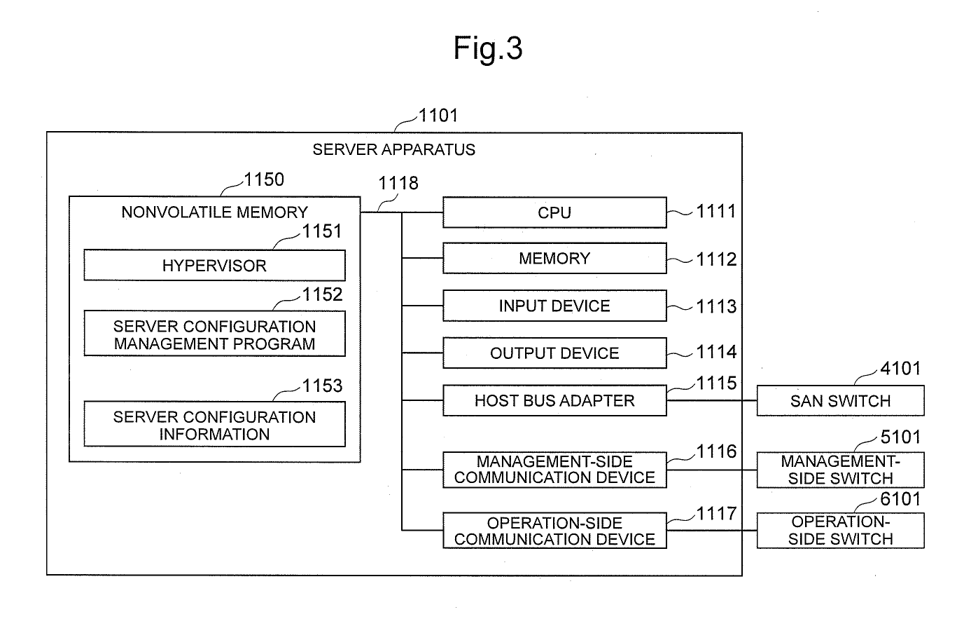

FIG. 3 shows the internal configuration diagram of the server apparatus 1101 of the replication source. The server apparatus 1101 is configured from a CPU (Central Processing Unit) 1111 that governs the operational control of the server apparatus 1101, a memory 1112, an input device 1113, an output device 1114, a host bus adapter 1115, a management-side communication device 1116, an operation-side communication device 1117 and a nonvolatile memory 1150. These physical resources are mutually and communicably connected via the system bus 1118.

The CPU 1111 loads, into the memory 1112, the various programs stored in the nonvolatile memory 1150, and executes the orders described in the various programs. The act of the CPU executing the orders described in a program is sometimes explained by being described as “executing a program”.

The memory 1112 loads the various programs stored in the nonvolatile memory 1150, and stores data that is generated upon executing a program. The input device 1113 is a device for receiving inputs from a user and, for example, is a keyboard or a mouse. The output device 1114 is a device for displaying an output to the user and, for example, is a display device.

The host bus adapter 1115 is connected to the SAN switch 4101, and performs I/O processing between the server apparatus 1101 and the storage apparatus 3101. The management-side communication device 1116 is connected to the management-side switch 5101, and performs send/receive processing of receiving a management operation execution request from the management computer 711, and sending a management operation execution result to the management computer 711.

The operation-side communication device 1117 is connected to the operation-side switch 6101, and performs send/receive processing of receiving a test execution request from the test computer 811 or 812, and sending a test execution result to the test computer 811 or 812.

The nonvolatile memory 1150 stores an OS, various programs and various data required for the operation of the server apparatus 1101, as well as a hypervisor 1151, a server configuration management program 1152 and server configuration information 1153.

The hypervisor 1151 is a program for operating the virtual machines 2101 and 2102 running on the server apparatus 1101, and performs resource management of the virtual machines 2101 and 2102 by distributing the physical resources such as the CPU 1111, the memory 1112, the host bus adapter 1115 and the operation-side communication device 1117 to the virtual machines 2101 and 2102, and virtualizing the physical resources so that they can be shared between the virtual machines 2101 and 2102.

The server configuration management program 1152 is a program for acquiring configuration information of the server apparatus 1101, distributing the physical resources to the virtual machines 2101 and 2102 running on the server apparatus 1101, setting the addresses of the logical host bus adapter 2115 and the logical NIC 2116 (FIG. 4), and activating or stopping the virtual machines 2101 and 2102. Note that the management computer 711 can execute the server configuration management program 1152 via the management-side communication device 1116.

The server configuration information 1153 stores information indicating the relation of the virtual machines 2101 and 2102 running on the server apparatus 1101 and the virtual machine images, information indicating the amount of physical resources distributed to the virtual machines 2101 and 2102, and configuration information of the server apparatus 1101 including the address of the logical host bus adapter 2115 or the logical NIC 2116 (FIG. 4). Note that information, in which the test environment identifying information is added to the server configuration information 1153, is stored in the management computer 711 as the server configuration information 7156.

Since the internal configuration of the server apparatus 1102 is similar to the configuration of the server apparatus 1101 described above, the explanation thereof is omitted.

FIG. 4 shows the internal configuration of the virtual machine 2101. The virtual machine 2101 is configured from a logical CPU 2111 that governs the operational control of the virtual machine 2101, a logical memory 2112, a logical input device 2113, a logical output device 2114, a logical host bus adapter 2115, a logical NIC (Network Interface Card) 2116 and a logical disk 2150. Moreover, the logical resources are mutually and communicably connected via the system bus 2117.

The logical CPU 2111 is a logical CPU that is assigned from the hypervisor 1151 to the virtual machine 2101. The logical CPU 2111 loads, into the logical memory 2112, the various programs stored in the logical disk 2150, and executes the orders described in the various programs. The act of the logical CPU executing the orders described in a program is sometimes explained by being described as “executing a program”.

The logical memory 2112 is a logical memory that is assigned from the hypervisor 1151 to the virtual machine 2101. The logical memory 2112 loads programs stored in the logical disk 2150, and stores data that is generated upon executing a program. The logical input device 2113 is a logical input device that is assigned from the hypervisor 1151 to the virtual machine 2101.

The logical input device 2113 is a device for receiving inputs from a user and, for example, is a keyboard or a mouse. The logical output device 2114 is a logical output device that is assigned from the hypervisor 1151 to the virtual machine 2101. The logical output device 2114 is a device for displaying an output to the user and, for example, is a disk play device.

The logical host bus adapter 2115 is a logical host bus adapter that is assigned from the hypervisor 1151 to the virtual machine 2101. The logical host bus adapter 2115 is connected to the SAN switch 4101 via the host bus adapter 1115, and performs I/O processing between the virtual machine 2101 and the storage apparatus 3101.

The logical communication device 2116 is a logical communication device that is assigned from the hypervisor 1151 to the virtual machine 2101. The logical communication device 2116 is connected to the operation-side switch 6101 via the operation-side communication device 1117, and performs send/receive processing of receiving a test execution request from the test computer 811 or 811, and sending a test execution result to the test computer 811 or 812.

The logical disk 2150 stores an OS, various programs and various data required for the operation of the virtual machine 2101, as well as a test application 2151. The test application 2151 is an application for performing tests, and executes processing according to a test execution request from the test computer 811 or 812, and sends a test execution result to the test computer 811 or 812.

Since the configuration of the virtual machines 2102, 2103 and 2104 is similar to the configuration of the virtual machine 2101 described above, the explanation thereof is omitted.

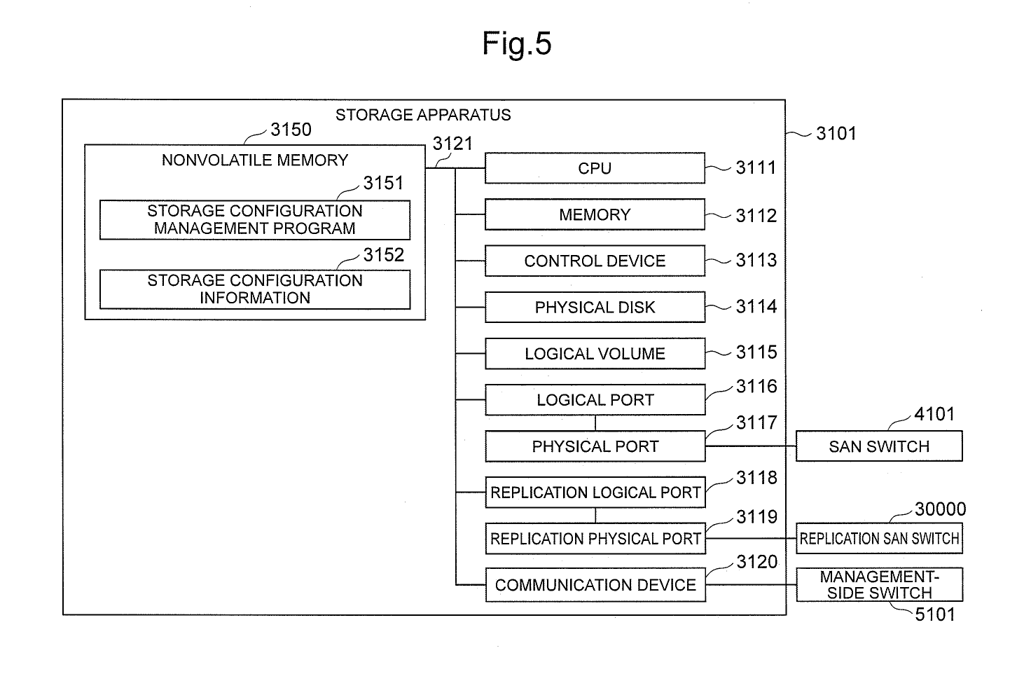

FIG. 5 shows the internal configuration of the storage apparatus 3101. The storage apparatus 3101 is configured from a CPU 3111 that governs the operational control of the storage apparatus 3101, a memory 3112, a control apparatus 3113, a physical disk 3114, a physical port 3117, a replication physical port 3119, a communication device 3120 and a nonvolatile memory 3150. Moreover, these physical resources are mutually and communicably connected via a system bus 3121.

Moreover, set in the storage apparatus 3101 are logical resources such as the logical volume 3115, the logical port 3116 and the replication logical port 3118 which are provided by the physical resources.

The CPU 3111 loads, into the memory 3112, the various programs stored in the nonvolatile memory 3150, and executes the orders described in the various programs.

The memory 3112 loads the various programs stored in the nonvolatile memory 3150, and stores data that is generated upon executing the various programs. The control apparatus 3113 manages physical resources including the CPU 3111, the memory 3112 and the communication device 3120, and additionally controls the physical port 3117 and the physical disk 3114.

The physical disk 3114 stores application programs and data. Normally, a plurality of physical disks 3114 are provided, and the plurality of physical disks 3114 are given redundancy and configured as virtual disks. While a RAID (Redundant Arrays of Inexpensive Disks) may be illustrated as an example of a configuration with redundancy, the configuration is not limited to RAID.

The logical volume 3115 provides a storage area for storing data of the server apparatuses 1101 and 1102 and the image files of the virtual machines 2101 to 2104. The substance of the storage area provided by the logical volume 3115 is assigned from the physical disk 3114. The logical port 3116 is a logical port that is assigned from the physical port 3117 and connected to the SAN switch 4101, and performs I/O processing between the virtual machines 2101 to 2104 and the storage apparatus 3101.

The physical port 3117 is connected to the SAN switch 4101, and performs I/O processing between the server apparatus 1101 or 1102 and the storage apparatus 3101. The replication logical port 3118 is a logical port that is assigned from the replication physical port 3119 and connected to the replication SAN switch 30000, and performs I/O processing between the logical volume of the replication source, and the logical volume allocated in the integrated system 112 of the replication destination.

The replication physical port 3119 is connected to the replication SAN switch 30000, and used for creating a replication in the storage apparatus in the integrated system 112 of the replication destination. The communication device 3120 is connected to the management-side switch 5101, and performs send/receive processing of receiving a management operation execution request from the management computer 711, and sending a management operation execution request to the management computer 711.

The nonvolatile memory 3150 stores an OS, various programs and various data required for the operation of the storage apparatus 3101, as well as a storage configuration management program 3151 and storage configuration information 3152.

The storage configuration management program 3151 is a program for acquiring configuration information of the storage apparatus 3101, creating or deleting a logical volume in the storage apparatus 3101, creating or deleting the logical port 3116 or the replication logical port 3118 or causing it to go online or offline, assigning the logical port 3116 to the logical volume, setting identifying information in the logical volume, and replicating the data stored in the logical volume. Note that the management computer 711 can execute the storage configuration management program 3151 via the communication device 3120.

The storage configuration information 3152 stores configuration information including a plurality of physical resources in the storage apparatus 3101, and logical resources such as a logical volume, a logical port and a replication logical which are configured from these physical resources. Note that information, in which the test environment identifying information is added to the storage configuration information 3152, is stored in the management computer 711 as the storage configuration information 7157.

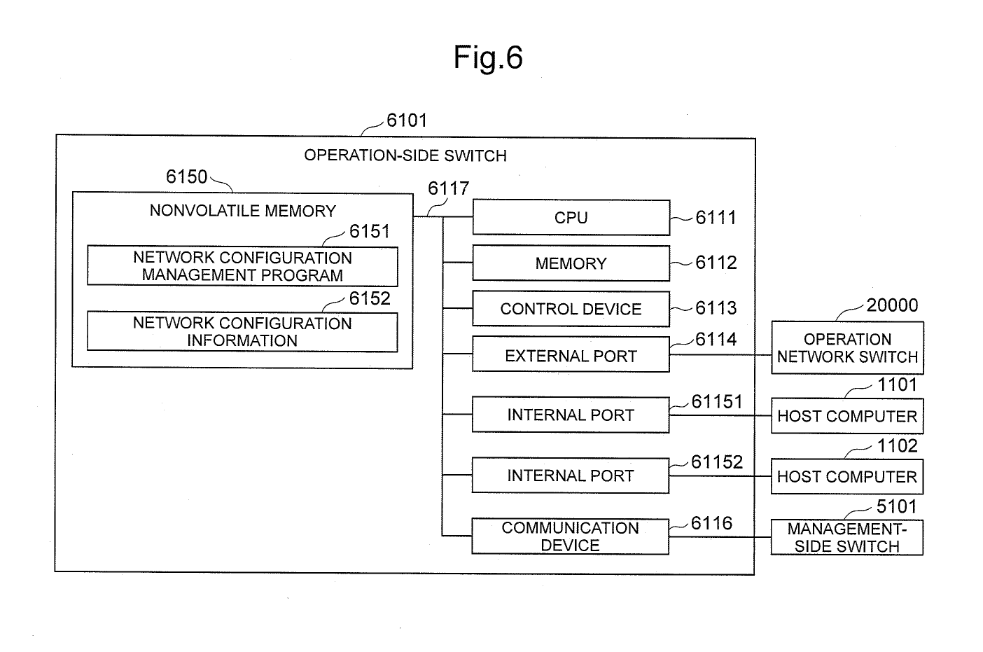

FIG. 6 shows the internal configuration of the operation-side switch 6101. The operation-side switch 6101 is configured from a CPU 6111 that governs the operational control of the operation-side switch 6101, a memory 6112, a control apparatus 6113, an external port 6114, internal ports 61151, 61152, a communication device 6116 and a nonvolatile memory 6150. Moreover, these physical resources are mutually and communicably connected via the system bus 6117.

The CPU 6111 loads, into the memory 6112, the various programs stored in the nonvolatile memory 6150, and executes the orders that are described in the various programs.

The memory 6112 loads the various programs stored in the nonvolatile memory 6150, and stores various data that are generated upon executing a program. The control apparatus 6113 manages physical resources including the CPU 6111, the memory 6112 and the communication device 6116, and controls the external port 6114, and the internal ports 61151 and 61152.

The external port 6114 is connected to the operation network switch 20000, and performs communication processing between the integrated system 111 and the test computer 811 or 812. The internal port 61151 is connected to the server apparatus 1101, and performs communication processing between the operation-side switch 6101 and the server apparatus 1101. Moreover, the internal port 61152 is connected to the server apparatus 1102, and performs communication processing between the operation-side switch 6101 and the server apparatus 1102.

The communication device 6116 is connected to the management-side switch 5101, and performs send/receive processing of receiving a management operation execution request from the management computer 711, and sending a management operation execution result to the management computer 711.

The nonvolatile memory 6150 stores an OS, various programs and various data required for the operation of the operation-side switch 6101, as well as a network configuration management program 6151 and network configuration information 6152.

The network configuration management program 6151 is a program for acquiring configuration information of the operation-side switch 6101, controlling communication between an external switch and an internal switch in the operation-side switch 6101, setting an external address to the internal network, and controlling the permission or prohibition of communication according to the protocol, the port number, and the direction of communication (external network to internal network or internal network to external network). Note that the management computer 711 can execute the network configuration management program 6151 via the communication device 3120.

The network configuration information 6152 stores configuration information including configuration information of the external address to the internal network, and configuration information regarding the permission or prohibition of communication according to the protocol, the port number, and the direction of communication. Note that information, in which the test environment identifying information is added to the network configuration information 6152, is stored in the management computer 711 as the network configuration information 7158.

Note that, in this embodiment, while the network configuration management program 6151 and the network configuration information 6152 are explained as being stored in the operation-side switch 6101, a computer that runs a firewall may also be disposed between the operation-side switch 6101 and the operation network switch 20000.

Since the internal configuration of the management-side switch 5101 is similar to the internal configuration of the operation-side switch 6101 described above, the explanation thereof is omitted.

FIG. 7 shows the internal configuration of the management computer 711. The management computer 711 is configured from a CPU 7111 that governs the operational control of the management computer 711, a memory 7112, an input device 7113, an output device 7114, a communication device 7115, and a nonvolatile memory 7150. Moreover, these physical resources are mutually and communicably connected via the system bus 7116.

The CPU 7111 loads, into the memory 7112, the various programs stored in the nonvolatile memory 7150, and executes the orders described in the various programs.

The memory 7112 loads the various programs stored in the nonvolatile memory 7150, and stores data that is generated upon executing various programs.

The input device 7113 is a device for receiving inputs from the user and, for example, is a keyboard or a mouse. The output device 7114 is a device for displaying an output to the user and, for example, is a disk play device.

The communication device 7115 is connected to the management network switch 10000, and performs send/receive processing of sending a management operation execution request to the server apparatuses 1101, 1102, the storage apparatus 3101 and the various switches, and receiving a management operation execution result from these devices and switches.

The nonvolatile memory 7150 stores an OS, various programs and various data required for the operation of the management computer 711, as well as a system configuration acquisition program 7151, a test environment replication program 7152, management program information 7153, VM configuration definition information 7154, external address assignment information 7155, server configuration information 7156, storage configuration information 7157 and network configuration information 7158.

The system configuration acquisition program 7151 sends a configuration information acquisition request to the server configuration management program 1152, the storage configuration management program 3151 and the network configuration management program 6151, and receives configuration information as an execution result. In addition, the server configuration information 7156, the storage configuration information 7157 and the network configuration information 7158 are stored in the nonvolatile memory 7150. Note that the system configuration acquisition program 7151 may be executed according an administrator's request, or executed periodically according to a scheduler of an OS or the like.

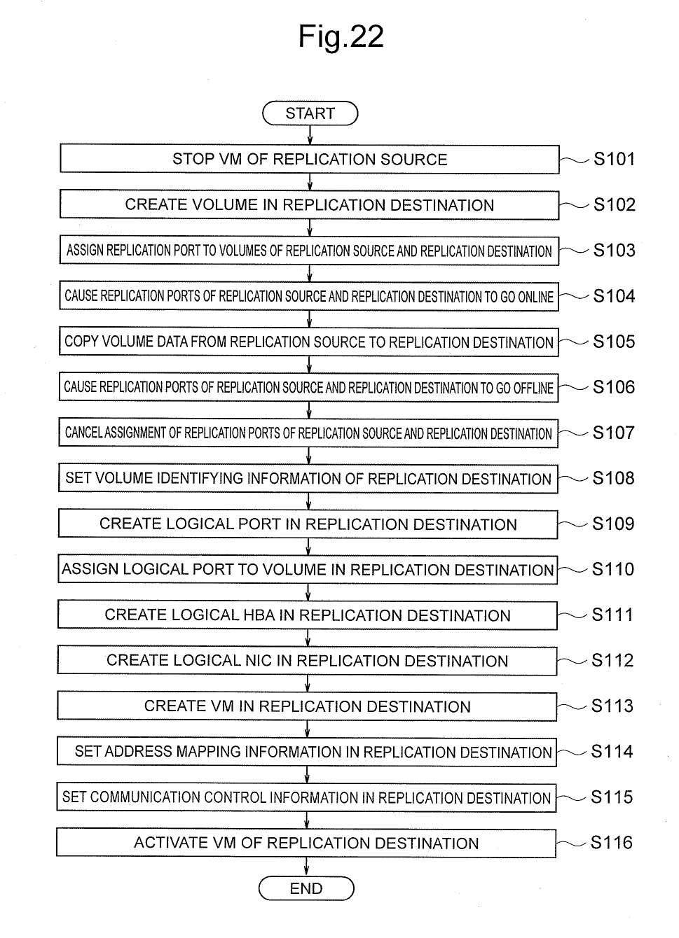

The test environment replication program 7152 is a program for replicating, in the integrated system 112 of the replication destination, the test environment constructed in one integrated system 111. The test environment replication program 7152 creates a replication of the test environment by sending a configuration change execution request to the server apparatus (server configuration management program), the storage apparatus (storage configuration management program) and the operation-side switch (network configuration management program) in the integrated system 112 of the replication destination. Details of the test environment replication processing will be described later (FIG. 22).

The management program information 7153 includes the address information that is used upon sending a configuration change execution request to the server apparatus 1101 (server configuration management program 1152), the storage apparatus 3101 (storage configuration management program 3151) and the operation-side switch 6101 (network configuration management program 6151) in the integrated system 111. Details will be described later (FIG. 9).

The VM configuration definition information 7154 includes configuration including the virtual machines 2101 to 2104 operating in the integrated system 111, the logical host bus adapter 2115 assigned to the virtual machines 2101 to 2104, and the logical port 3116 connected to the logical host bus adapter 2115. Details will be described later (FIG. 10).

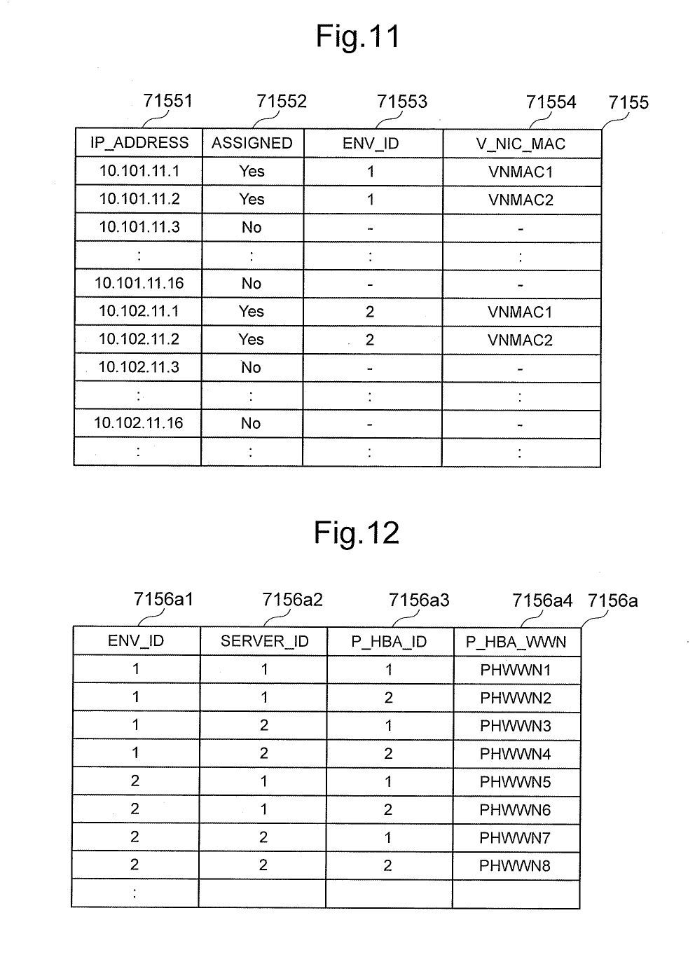

The external address assignment information 7155 includes information including an external address that is used upon using the network configuration management program 6151 and performing setting operations to the operation-side switch 6101. Details will be described later (FIG. 11).

The server configuration information 7156 includes information in which the test environment identifying information is added to the server configuration information 1153 acquired from the server configuration management program 1152. Moreover, the storage configuration information 7157 includes information in which the test environment identifying information is added to the storage configuration information 3152 acquired from the storage configuration management program 3151. Moreover, the network configuration information 7158 includes information in which the test environment identifying information is added to the network configuration information 6152 acquired from the network configuration management program 6151. Details will be described later (FIG. 12 to FIG. 21).

FIG. 8 shows the internal configuration of the test computer 811. The test computer 811 is configured from a CPU 8111 that governs the operational control of the test computer 811, a memory 8112, an input device 8113, an output device 8114, a communication device 8115 and a nonvolatile memory 8150. Moreover, these physical resources are mutually and communicably connected via the system bus 8116.

The CPU 8111 loads, into the memory 8112, the various programs stored in the nonvolatile memory 8150, and executes the orders that are described in the various programs.

The memory 8112 loads the various programs stored in the nonvolatile memory 8150, and stores data that is generated upon executing the various programs.

The input device 8113 is a device for receiving inputs from the user and, for example, is a keyboard or a mouse. The output device 8114 is a device for displaying an output to the user and, for example, is a disk play device. The communication device 8115 is connected to the operation network switch 20000, and performs send/receive processing of receiving a test execution request from the test computer 811, and sending a test execution result to the test computer 811.

The nonvolatile memory 8150 stores an OS, various programs and various data that are required for the operation of the test computer 811, as well as a test execution program 8151.

The test execution program 8151 is a program for causing the test application 2151 to execute a test, sending a test execution request to the test application 2125, and receiving a test result from the test application 2125.

Since the internal configuration of the test computer 812 is similar to the configuration of the test computer 811 described above, the explanation thereof is omitted.

### (1-3) Details of Each Configuration

FIG. 9 shows the logical configuration of the management program information 7153. The management program 7153 is information that is created as a result of the administrator registering the equipment in the management computer 711, and stores the respective addresses of the server apparatus, the storage apparatus and the operation-side switch. The management program information 7153 is used in the test environment construction processing (FIG. 22). Note that the various types of information and various tables described later are also similarly used in the test environment construction processing.

Specifically, the management program information 7153 is configured from a test environment identifying information column 71531, an apparatus type column 71532, an apparatus ID column 71533 and an address column 71534.

The test environment identifying information column 71531 stores test environment identifying information for identifying a unique integrated system in the test execution system 1. Moreover, the apparatus type column 71532 stores information indicating the type of the respective devices configuring the integrated system. Moreover, the apparatus ID column 71533 stores the identifying information of the respective devices configuring the integrated system. Moreover, the address column 71534 stores an address that is used for the management computer 711 to send an execution request to the management program (for example, the server configuration management program 1152) in the respective devices configuring the integrated system.

Accordingly, the case of FIG. 9 shows that, for example, the integrated system having the test environment identifying information of “1” is configured from two server apparatuses in which the apparatus type is “Server”, one storage apparatus in which the apparatus type is “Storage”, and one operation-side switch in which the apparatus type is “Switch”. FIG. 9 additionally shows that the address of the server apparatus, in which the apparatus type is “Server” and the apparatus ID is “1”, is “192.168.10.1”. Note that, here, it is assumed that the test environment identifying information of the integrated system 111 is “1”, and the test environment identifying information of the integrated system 112 is “2”.

FIG. 10 shows the logical configuration of the VM configuration definition information 7154. The VM configuration definition information 7154 is information that is created by the administrator registering the virtual machines in the management computer 711, and stores information related to the connection between the virtual machine and the logical volume.

Specifically, the VM configuration definition information 7154 is configured from a virtual machine ID column 71541, a logical host bus adapter WWN column 71542, a logical port WWN column 71543 and a logical volume identifier column 71544.

The virtual machine ID column 71541 stores identifying information for identifying a unique virtual machine in the integrated system. The logical host bus adapter WWN column 71542 stores the World Wide Name (WWN) of the logical host bus adapter assigned to the virtual machine as the information for identifying a globally unique logical host bus adapter. The logical port WWN column 71543 stores the WWN of the logical port as the information for identifying a globally unique logical port. The logical volume identifier column 71544 stores information for identifying a unique logical volume in the integrated system, and stores, for example, identifying information of the logical volume to be stored in Page 83h of the response data of the SCSI INQUIRY command.

Accordingly, the case of FIG. 10 shows that, for example, the logical host bus adapter in which the logical host bus adapter WWN is “VHWWN1” is assigned to the virtual machine in which the virtual machine ID is “1”, and the logical host bus adapter is connected to the logical port in which the logical port WWN is “VPWWN1” and the logical volume in which the identifier of the logical volume is “VOL1”.

FIG. 11 shows the logical configuration of the external address assignment information 7155. The external address assignment information 7155 is information that is created by the administrator registering, as a reservation, the address to be assigned to the logical NIC in the management computer 711, and stores information indicating the reserved address and whether that address has been assigned.

Specifically, the external address assignment information 7155 is configured from a logical NIC address column 71551, an assigned column 71552, a test environment identifying information column 71553 and a logical NIC MAC address column 71554.

The logical NIC address column 71551 stores the IP address that was reserved in the test execution system 1 to be assigned to the logical NIC of the virtual machine. The assigned column 71552 stores information showing whether the logical NIC has been assigned. The test environment identifying information column 71553 stores the test environment identifying information for identifying a unique integrated system in the test execution system 1. The logical NIC MAC address column 71554 stores the MAC address of the logical NIC.

Accordingly, the case of FIG. 11 shows that, for example, a virtual machine has already been assigned to the logical NIC having an address of “10.101.11.1” (“Yes”), this logical NIC is allocated to the integrated system 111, and the MAC address is “VNMAC1”.

FIG. 12 shows the logical configuration of the physical HBA information 7156a included in the server configuration information 7156. The physical HBA information 7156a is information that is created by the administrator registering that information in the management computer 711, and stores information of the physical host bus adapter.

Specifically, the physical HBA information 7156a is configured from a test environment identifying information column 7156a1, a server apparatus ID column 7156a2, a physical host bus adapter ID column 7156a3 and a physical host bus adapter WWN column 7156a4.

The test environment identifying information column 7156a1 stores test environment identifying information for identifying a unique integrated system in the test execution system 1. The server apparatus ID column 7156a2 stores identifying information for identifying a unique server apparatus in the integrated system. The physical host bus adapter ID column 7156a3 stores identifying information for identifying a unique physical host bus adapter in the server apparatus. The physical host bus adapter WWN column 7156a4 stores the WWN for identifying a globally unique physical host bus adapter.

Accordingly, the case of FIG. 12 shows that, for example, two storage apparatuses having a server apparatus ID of “1” and two storage apparatuses having a server apparatus ID of “2” (total of four server apparatuses) are allocated in the integrated system in which the test environment identifying information is “1”. Moreover, two physical host bus adapters having a physical host bus adapter ID of “1” and “2” are allocated in the server apparatus having a server apparatus ID of “1”, and the WWN of the physical host bus adapter having a physical host adapter ID of “1” is “PHWWN1”.

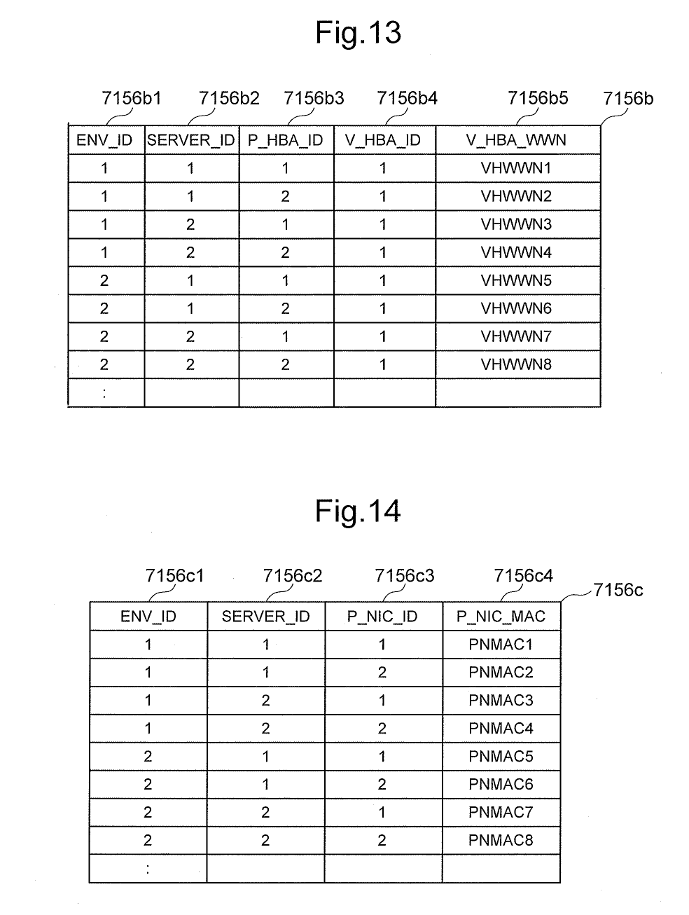

FIG. 13 shows the logical configuration of the logical HBA information 7156b included in the server configuration information 7156. The logical HBA information 7156b is information that is created as a result of the administrator registering that information in the management computer 711, and stores information of the logical host bus adapter.

Specifically, the logical HBA information 7156b is a configured from a test environment identifying information column 7156b1, a server apparatus ID column 7156b2, a physical host bus adapter ID column 7156b3, a logical host bus adapter ID column 7156b4 and a logical host bus adapter WWN column 7156b5.

The test environment identifying information column 7156b1 stores test environment identifying information for identifying a unique integrated system in the test execution system 1. The server apparatus ID column 7156b2 stores identifying information for identifying a unique server apparatus in the integrated system. The physical host bus adapter ID column 7156b3 stores identifying information for identifying a unique physical host bus adapter in the server apparatus. The logical host bus adapter ID column 7156b4 stores identifying information of a physical host bus adapter. The logical host bus adapter WWN column 7156b5 stores the WWN of the logical host bus adapter.

Accordingly, the case of FIG. 13 shows that, for example, two storage apparatuses having a server apparatus ID of “1” and two storage apparatuses having a server apparatus ID of “2” (total of four server apparatuses) are allocated in the integrated system in which the test environment identifying information is “1”. Moreover, FIG. 13 shows that two physical host bus adapters having a physical host bus adapter ID of “1” and “2” are allocated in the server apparatus having a server apparatus ID of “1”, and a logical host adapter having a logical host adapter ID of “1” is assigned to a logical host adapter having a logical host adapter ID of “1”. Moreover, the WWN of this logical host adapter is “VHWWN1”.

FIG. 14 shows the logical configuration of the physical NIC information 7156c included in the server configuration information 7156. The physical NIC information 7156c is information that is created by the administrator registering that information in the management computer 711, and stores information of the physical NIC.

Specifically, the physical NIC information 7156c is configured from a test environment identifying information column 7156c1, a server apparatus ID column 7156c2, a physical NIC ID column 7156c3 and a physical NIC MAC address column 7156c4.

The test environment identifying information column 7156c1 stores test environment identifying information for identifying a unique integrated system in the test execution system 1. The server apparatus ID column 7156c2 stores identifying information for identifying a unique server apparatus in the integrated system. The physical NIC ID column 7156c3 stores identifying information of the physical NIC. The physical NIC MAC address column 7156c4 stores the MAC address of a physical NIC.

Accordingly, the case of FIG. 14 shows that, for example, two storage apparatuses having a server apparatus ID of “1” and two storage apparatuses having a server apparatus ID of “2” (total of four server apparatuses) are allocated in the integrated system in which the test environment identifying information is “1”. Moreover, FIG. 14 shows that two physical NICs having a physical NIC ID of “1” and “2” are allocated in the server apparatus having a server apparatus ID of “1”, and the MAC address of the physical NIC having a physical NIC ID of “1” is “PNMAC1”.

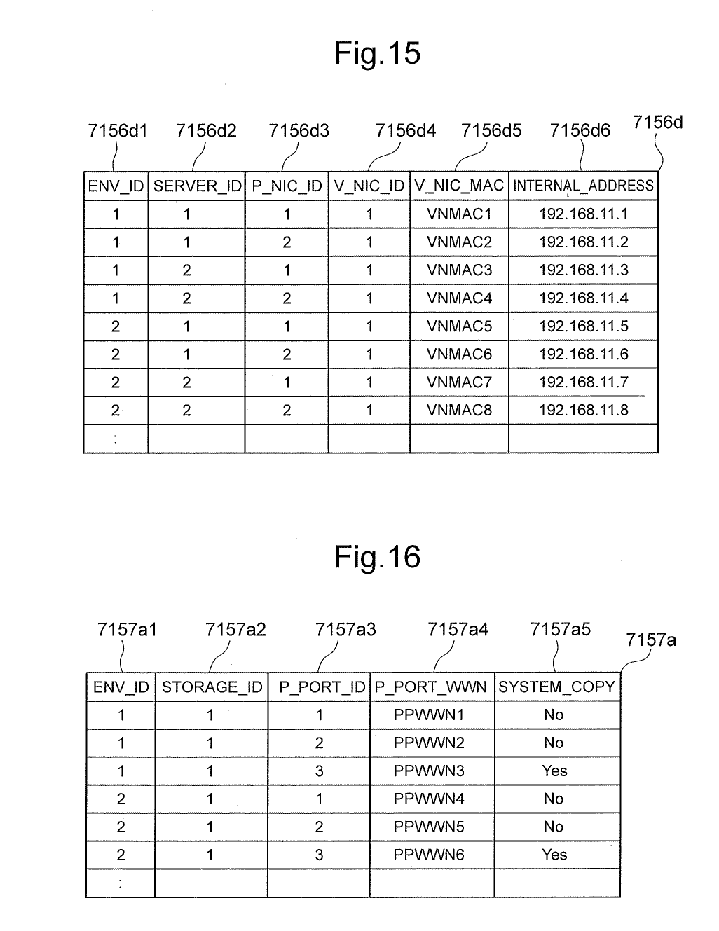

FIG. 15 shows the logical configuration of the logical NIC information 7156d included in the server configuration information 7156. The logical NIC information 7156d is information that is created by the administrator registering that information in the management computer 711, and stores information of the logical NIC.

Specifically, the logical NIC information 7156d is configured from a test environment identifying information column 7156d1, a server apparatus ID column 7156d2, a physical NIC ID column 7156d3, a logical NIC ID column 7156d4, a logical NIC MAC address column 7156d5 and an internal address column 7156d6.

The test environment identifying information column 7156d1 stores test environment identifying information for identifying a unique integrated system in the test execution system 1. The server apparatus ID column 7156d2 stores identifying information for identifying a unique server apparatus in the integrated system. The physical NIC ID column 7156d3 stores identifying information of the physical NIC. The logical NIC ID column 7156d4 stores identifying information of the logical NIC. The logical NIC MAC address column 7156d5 stores the MAC address of the logical NIC that is created from the physical NIC. The internal address column 7156d6 stores an address assigned to the logical NIC for use in communication in the integrated system.

Accordingly, the case of FIG. 15 shows that, for example, two storage apparatuses having a server apparatus ID of “1” and two storage apparatuses having a server apparatus ID of “2” (total of four server apparatuses) are allocated in the integrated system in which the test environment identifying information is “1”. Moreover, FIG. 15 shows that two physical NICs having a physical NIC ID of “1” and “2” are allocated in the server apparatus having a server apparatus ID of “1”, the ID of the logical NIC created from the physical NIC having a physical NIC ID of “1” is “1”, and the MAC address of the logical NIC is “VNMAC1”. Moreover, the internal address of the logical NIC is “192.168.11.1”.

FIG. 16 shows the logical configuration of the physical port information 7157a included in the storage configuration information 7157. The physical port information 7157a is information that is created as a result of the administrator registering that information in the management computer 711, and stores information of the physical port.

Specifically, the physical port information 7157a is configured from a test environment identifying information column 7157a1, a storage apparatus ID column 7157a2, a physical port ID column 7157a3, a physical port WWN column 7157a4 and a system copy column 7157a5.

The test environment identifying information column 7157a1 stores test environment identifying information for identifying a unique integrated system in the test execution system 1. The storage apparatus ID column 7157a2 stores identifying information for identifying a unique storage apparatus in the integrated system. The physical port ID column 7157a3 stores identifying information for identifying a unique physical port in the storage apparatus. The physical port WWN column 7157a4 stores the WWN of the physical port. The system copy column 7157a5 stores information indicating whether the physical port is the physical port of the test environment replication to be connected to the replication SAN switch 30000.

Accordingly, the case of FIG. 16 shows that, for example, one storage apparatus having a storage apparatus ID of “1” is allocated in the integrated system in which the test environment identifying information is “1”, and a total of three physical ports having a physical port ID of “1” to “3” are allocated in the storage apparatus. Moreover, FIG. 16 shows that the WWN of the physical port having a physical port ID of “1” is “PPWWN1”, and the physical port cannot be used for test environment replication (“No”). Moreover, FIG. 16 shows that the physical port having a WWN of “PPWWN3” can be used for test environment replication (“Yes”). Note that the initial value of the system copy column 7157a5 is “No” in all physical ports, and this is set to “Yes” after connection.

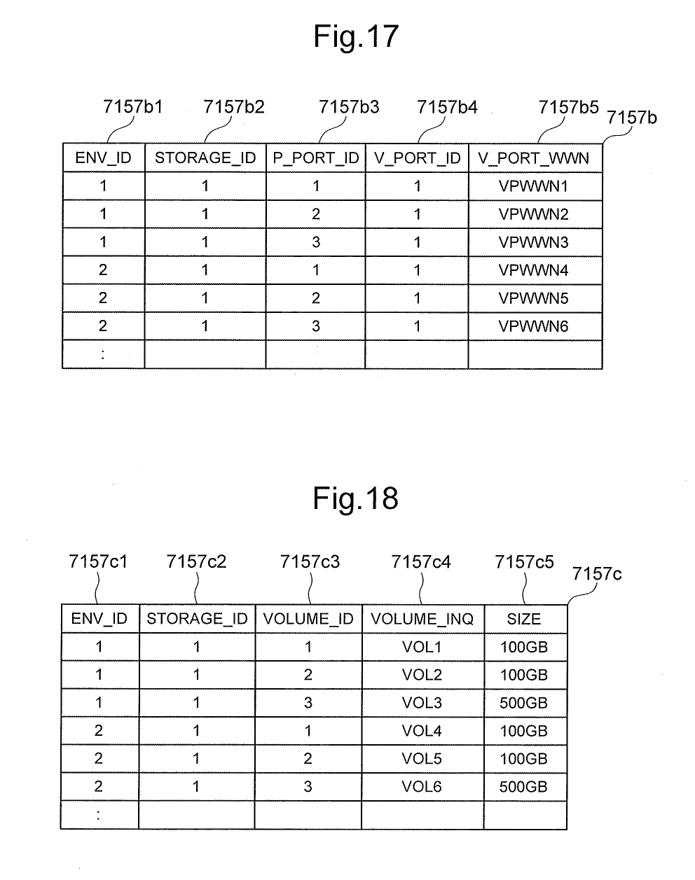

FIG. 17 shows the logical configuration of the logical port information 7157b included in the storage configuration information 7157. The logical port information 7157b is information that is created as a result of the administrator registering that information in the management computer 711, and stores information of the logical port.

Specifically, the logical port information 7157b is configured from a test environment identifying information column 7157b1, a storage apparatus ID column 7157b2, a physical port ID column 7157b3, a logical port ID column 7157b4 and a logical port WWN column 7157b5.

The test environment identifying information column 7157b1 stores test environment identifying information for identifying a unique integrated system in the test execution system 1. The storage apparatus ID column 7157b2 stores identifying information for identifying a unique storage apparatus in the integrated system. The physical port ID column 7157b3 stores identifying information for identifying a unique physical port in the storage apparatus. The logical port ID column 7157b4 stores identifying information for identifying a unique logical port in the physical port. The logical port WWN column 7157b5 stores the WWN of the logical port.

Accordingly, the case of FIG. 17 shows that, for example, one storage apparatus having a storage apparatus ID of “1” is allocated in the integrated system in which the test environment identifying information is “1”, and a total of three physical ports having a physical port ID of “1” to “3” are allocated in the storage apparatus. Moreover, FIG. 17 shows that the logical port having a logical port ID of “1” is created from the physical port having a physical port ID of “1”, and the WWN of this logical port is “VPWWN1”.

FIG. 18 shows the logical configuration of the logical volume information 7157c included in the storage configuration information 7157. The logical volume information 7157c is information that is created as a result of the administrator registering that information in the management computer 711, and stores information of the logical volume.

Specifically, the logical volume information 7157c is configured from a test environment identifying information column 7157c1, a storage apparatus ID column 7157c2, a logical volume ID column 7157c3, a logical volume identifier column 7157c4 and a volume size column 7157c5.

The test environment identifying information column 7157c1 stores test environment identifying information for identifying a unique integrated system in the test execution system 1. The storage apparatus ID column 7157c2 stores identifying information for a identifying a unique storage apparatus in the integrated system. The logical volume ID column 7157c3 stores identifying information for identifying a unique logical volume in the storage apparatus. The logical volume identifier column 7157c4 stores information for identifying a unique logical volume in the integrated system, and, for example, stores identifying information of the logical volume stored in Page 83h of the response data of the SCSI INQUIRY command. The volume size column 7157c5 stores the size of the logical volume.

Accordingly, the case of FIG. 18 shows that, for example, one storage apparatus having a storage apparatus ID of “1” is allocated in the integrated system in which the test environment identifying information is “1”, and a total of three logical volumes having a logical volume ID of “1” to “3” are allocated in the storage apparatus. Moreover, FIG. 18 shows that the identifying information of the logical volume having a logical volume ID of “1” is “VOL1”, and the volume size of the logical volume is “100 GB”.

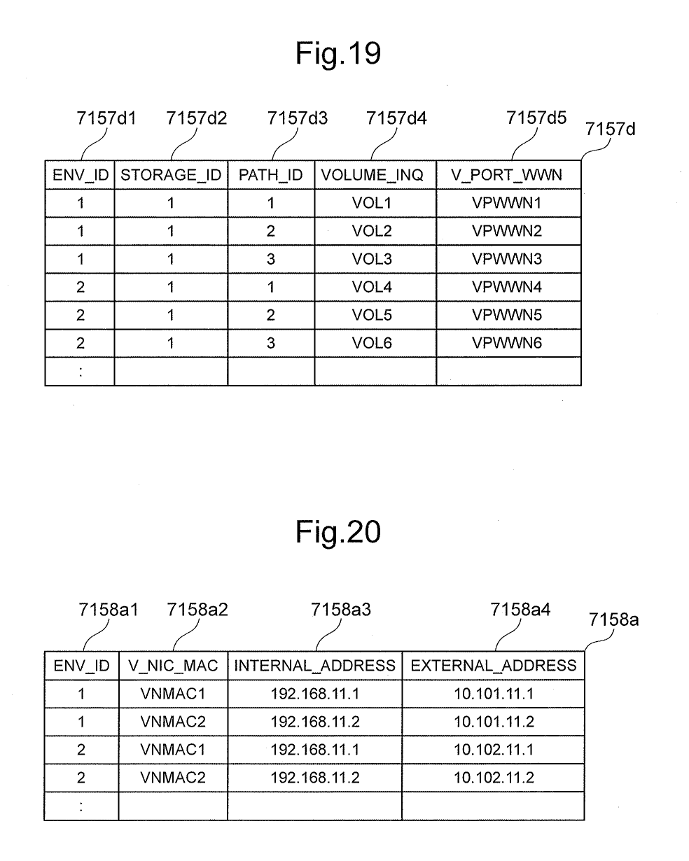

FIG. 19 shows the logical configuration of the path information 7157d included in the storage configuration information 7157. The path information 7157d is information that is created as a result of the administrator registering that information in the management computer 711, and stores information of the path connecting the logical port and the logical volume.

Specifically, the path information 7157d is configured from a test environment identifying information column 7157d1, a storage apparatus ID column 7157d2, a path ID column 7157d3, a logical volume identifier column 7157d4 and a logical port WWN column 7157d5.

The test environment identifying information column 7157d1 stores test environment identifying information for identifying a unique integrated system in the test execution system 1. The storage apparatus ID column 7157d2 stores identifying information for identifying a unique storage apparatus in the integrated system. The path ID column 7157d3 stores identifying information for identifying a unique path in the storage apparatus. The logical volume identifier column 7157d4 stores information for identifying a unique logical volume in the integrated system, and, for example, identifying information of the logical volume stored in Page 83h of the response data of the SCSI INQUIRY command. The logical port WWN column 7157d5 stores the WWN of the logical port.

Accordingly, the case of FIG. 19 shows that, for example, one storage apparatus having a storage apparatus ID of “1” is allocated in the integrated system in which the test environment identifying information is “1”, and a total of three paths having a path ID of “1” to “3” are allocated in the storage apparatus. Moreover, FIG. 19 shows that the path having a path ID of “1” is the path for connecting the logical volume in which the identifying information is “VOL1” and the logical port in which the WWN is “VPWWN1”.

FIG. 20 shows the logical configuration of the address mapping information 7158a included in the network configuration information 7158. The address mapping information 7158a is information that is created as a result of the administrator registering that information in the management computer 711, and stores information which associates the address for accessing the virtual machine (logical NIC) from the outside of the integrated system and the address for accessing the virtual machine (logical NIC) in the integrated system.

Specifically, the address mapping information 7158a is configured from a test environment identifying information column 7158a1, a logical NIC MAC address column 7158a2, an internal address column 7158a3 and an external address column 7158a4.

The test environment identifying information column 7158a1 stores test environment identifying information for identifying a unique integrated system in the test execution system 1. The logical NIC MAC address column 7158a2 stores the MAC address of the logical NIC. The internal address column 7158a3 stores the address assigned to the logical NIC for accessing the logical NIC of the virtual machine inside the integrated system. The external address column 7158a4 stores the address assigned to the logical NIC for accessing the logical NIC of the virtual machine from the outside of the integrated system.

Accordingly, the case of FIG. 20 shows that, for example, two logical NICs having a MAC address of “VNMAC1” and “VNMAC2” are set in the integrated system in which the test environment identifying information is “1”. Moreover, FIG. 20 shows that “192.168.11.1” is used for accessing the logical NIC having a MAC address of “VNMAC1” from the inside of the integrated system, and “10.101.11.1” is used for accessing from the outside of the integrated system.

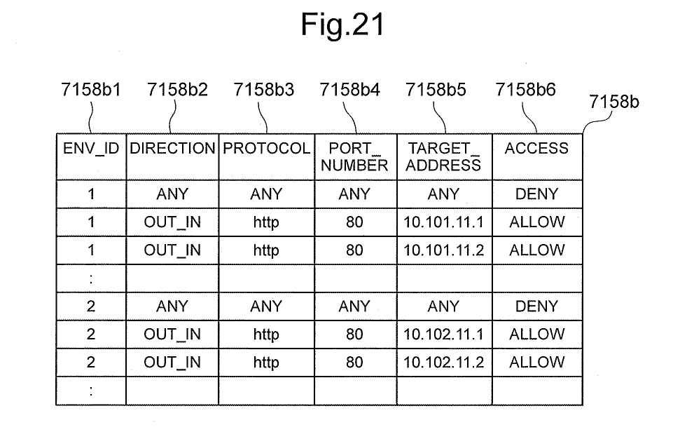

FIG. 21 shows the logical configuration of the communication control information 7158b included in the network configuration information 7158. The communication control information 7158b is information that is created as a result of the administrator registering that information in the management computer 711, and stores information related to the communication control between the integrated system and the outside.

Specifically, the communication control information 7158b is configured from a test environment identifying information column 7158b1, a communication direction column 7158b2, a protocol column 7158b3, a port number column 7158b4, a target address column 7158b5 and an access column 7158b6.

The test environment identifying information column 7158b1 stores test environment identifying information for identifying a unique integrated system in the test execution system 1. The communication direction column 7158b2 stores information showing the direction of communication. The protocol column 7158b3 stores the protocol that is used in communication. The port number column 7158b4 stores the port number. The target address column 7158b5 stores the address of the access destination. The access column 7158b6 stores information indicating the permission or prohibition of access.

Accordingly, the case of FIG. 21 shows that, for example, the integrated system in which the test environment identifying information is “1” is prohibited from communication of bidirectional “ANY” in which the communication direction may be either from the integrated system to the outside or from the outside to the integrated system, “ANY” in which any protocol may be used, “ANY” in which any port number may be used, and “ANY” in which any target address may be used (“DENY”). Moreover, FIG. 21 shows that communication in which the communication direction is from the outside to the integrated system (“OUT_IN”), the protocol is “http”, the port number is “80”, and the target address is “10.101.11.1” is allowed (“ALLOW”). Note that IN_OUT is stored in the communication direction column 7158b2 when the communication direction is from the integrated system to the outside.

### (1-4) Flowchart

FIG. 22 shows the processing routine of the test environment construction processing in this embodiment. The test environment construction processing is executed based on the test environment replication program 7152 and the CPU 7111 when the management computer 711 receives a request from the administrator.

Note that, here, the explanation is provided on the assumption that the management computer 711 received a request from the administrator for replicating, in the integrated system, a test environment that is constructed in the integrated system 111, and constructing a test environment in the integrated system 112. Moreover, for the sake of convenience of explanation, the processing substance is explained as the test environment replication program 7152.

Foremost, the test environment replication program 7152 refers to the management program information 7153, and sends a stop request of the virtual machine to the server apparatus (for example, server apparatus 1101 and 1102) in which the test environment identifying information is “1” and the apparatus type is “Server” (S101).

The server configuration management program 1152 of the replication source that receive the request in step S101 stops the virtual machine (for example, virtual machines 2101 to 2104) of the replication source.

Subsequently, the test environment replication program 7152 refers to the logical volume information 7157c, and creates, in the storage apparatus (for example, storage apparatus of the integrated system 112) in which the test environment identifying information is “2”, logical volumes in which the test environment identifying information is “1”, the storage apparatus ID is “1”, the logical volume ID is “1” to “3”, and the volume sizes are respectively “100 GB”, “100 GB” and “500 GB” (S102).

Note that, here, the test environment replication program 7152 refers to the management program information 7153, designates, as the storage apparatus of the replication destination, the storage apparatus in which the test environment identifying information is “2”, the apparatus type is “Storage”, and the apparatus ID is “1” (storage apparatus ID), and sends, to the storage apparatus, a creation request of the logical volume by designating a logical volume ID and a volume size that are the same as, and a logical volume identifier that is different from, the replication source.

The storage configuration management program 3151 of the replication destination that received the request in step S102 creates a logical volume in the replication destination.

Subsequently, the test environment replication program 7152 refers to the physical port information 7157a and the logical volume information 7157c, and sends an assignment request of assigning, to the logical volume in which the test environment identifying information is “1”, the physical port in which the test environment identifying information is “1” and the system copy is “Yes”. Similarly, the test environment replication program 7152 refers to the physical port information 7157a and the logical volume information 7157c, and sends an assignment request of assigning the logical volume in which the test identifying information is “2” to the physical port in which the test environment identifying information is “2” and the system copy is “Yes” (S103).

The storage configuration management program 3151 of the replication source and the replication destination that received the request in step S103 assigns the physical port designated in the designated volume in the replication source and the replication destination.

Subsequently, the test environment replication program 7152 sends an online request of the physical port assigned, in step S103, to the storage apparatus of the replication source and the replication destination (S104).

The storage configuration management program 3151 of the replication source and the replication destination that received the request in step S104 causes the designated physical port to go online.

Subsequently, the test environment replication program 7152 sends a data replication request of replicating the data stored in the respective logical volumes of the replication source in the respective logical volumes of the replication destination created in step S102 (S105).

The storage configuration management program 3151 of the replication source and the replication destination that received the request in step S105 copies the data of the designated logical volume.

Subsequently, the test environment replication program 7152 sends an offline request of the physical port assigned in step S103 (S106).

The storage configuration management program 3151 of the replication source and the replication destination that received the request in step S106 causes the designated physical port to go offline.

Subsequently, the test environment replication program 7152 sends an assignment cancellation request for cancelling the assignment of the physical port that was assigned in step S103 (S107).

The storage configuration management program 3151 of the replication source and the replication destination that received the request of step S107 cancels the assignment of the designated physical port.

Subsequently, the test environment replication program 7152 refers to the logical volume information 7157c, changes the logical volume identifier (“VOL4”, “VOL5”, “VOLE”) in which the test environment identifying information is “2” to the logical volume identifier (“VOL1”, “VOL2”, “VOL3”) in which the test environment identifying information is “1”, and sends a volume identifying information setting request to the storage apparatus of the integrated system 12 so that the logical volume identifiers of the replication source and the replication destination coincide (S108).

The storage configuration management program 3151 of the replication destination that received the request in step S108 sets, to the logical volume of the integrated system 112, the logical volume identifier that is the same as the logical volume of the integrated system 111.

Subsequently, the test environment replication program 7152 refers to the physical port information 7157a and the logical port information 7157b, and sends a logical port creation request to the storage apparatus in which the test environment identifying information is “2” so that the storage apparatus ID, the physical port ID, the logical port ID and the logical port WWN of the logical ports in which the test environment identifying information is “1” coincide (S109).

The storage configuration management program 3151 of the replication destination that received the request in step S109 creates the logical port ID designated by the physical port and the logical port of the logical port WWN designated in the storage apparatus ID and the physical port ID.

Subsequently, the test environment replication program 7152 refers to the path information 7157d, and sends a path creation request to the storage apparatus in which the test environment identifying information is “2” so that, with regard to all paths in which the test environment identifying information is “1”, the corresponding storage apparatus ID, path ID, logical volume identifier and logical port WWN coincide (S110).

The storage configuration management program 3151 of the replication destination that received the request in step S110 newly creates, in the storage apparatus in which the test environment identifying information is “2”, a path that is the same as the path in the storage apparatus in which the test environment identifying information is “1”, and assigns the logical port to the logical volume.

Subsequently, the test environment replication program 7152 refers to the physical HBA information 7156a and the logical HBA information 7156b, and sends a logical host bus adapter creation request to the server apparatus in which the test environment identifying information is “2” so that the server apparatus ID, the physical host bus adapter ID, the logical host bus adapter ID and the logical host bus adapter WWN of the logical host bus adapter in which the test environment identifying information is “1” coincide (S111).

The server configuration management program 1152 of the replication destination that received the request in step S111 creates, in the server apparatus in which the test environment identifying information is “2”, the logical host bus adapter having a configuration that is the same as the logical host bus adapter of the server apparatus in which the test environment identifying information is “1”.

Subsequently, the test environment replication program 7152 refers to the physical NIC information 7156c and the logical NIC information 7156d, and sends a logical NIC creation request to the server apparatus in which the test environment identifying information is “2” so that the server apparatus ID, the physical NIC ID, the logical NIC ID, the logical NIC MAC address and the internal address corresponding to the logical NIC in which the test environment identifying information is “1” coincide (S112).

The server configuration management program 1152 of the replication destination that received the request in step S112 creates, in the server apparatus in which the test environment identifying information is “2”, the logical NIC having a configuration that is the same as the logical NIC of the server apparatus in which the test environment identifying information is “1”.

Subsequently, the test environment replication program 7152 refers to the VM configuration definition information 7154, and sends a virtual machine creation request to the server apparatus in which the test environment identifying information is “2” (S113).

The server configuration management program 1152 of the replication destination that received the request in step S113 creates, in the server apparatus in which the test environment identifying information is “2”, the virtual machine having a configuration that is the same as the virtual machine in which the test environment identifying information is “1”.

Subsequently, the test environment replication program 7152 refers to the address mapping information 7158a, and sends an address mapping request to the operation-side switch in which the test environment information is “2” so that the internal address coincides with the logical NIC in which the test environment identifying information is “1” and a non-assigned address in the external address assignment information 7155 becomes the external address (S114).

The network configuration management program 6151 of the replication destination that received the request in step S114 creates, in the operation-side switch in which the test environment identifying information is “2”, address mapping in which only the external address is different among the address mapping in which the test environment identifying information is “1”.

Subsequently, the test environment replication program 7152 refers to the communication control information 7158b, and sends a communication control information setting request to the operation-side switch in which the test environment identifying information is “2” so that the communication control information set in the operation-side switch 6101 in which the test environment identifying information is “1” and the communication direction, the protocol, the port number and the access permission and prohibition coincide, and the external address becomes the address that was assigned in step 114 (S115).

The network configuration management program 6151 of the replication destination that received the request in step S115 creates, in the operation-side switch in which the test environment identifying information is “2”, communication control information in which only the external address is different among the communication control information in which the test environment identifying information is “1”.

Subsequently, the test environment replication program 7152 refers to the management program information 7153, and sends a virtual machine activation request to the server apparatus in which the test environment identifying information is “2” and the apparatus type is “Server” (S116).

The server configuration management program 1152 of the replication destination that received the request in step S116 ends this test environment construction processing as a result of activating the virtual machine. Since it is thereby possible to replicate the test environment, which was constructed in advance in the integrated system 111, in the integrated system 112, it is possible to send a test execution request by designating the external address that was assigned in step 114 from the test computer 811 or 812, and execute a test in the integrated system 112.

(1-5) Effect of this Embodiment

As explained above, according to the management computer 711 of this embodiment, a logical volume having a configuration that is the same as the integrated system of the replication source is created in the integrated system of the replication destination, the connection of the created logical volume and the logical volume of the replication source is caused to go online and the data stored in the logical volume of the replication source is replicated in the logical volume of the replication destination, and, after the replication, the connection is caused to go offline and the identifying information of the logical volume of the replication destination is set to coincide with the identifying information of the logical volume of the replication source, a logical port is set in the other storage apparatuses of the replication destination, the logical host bus adapter, the logical NIC and the virtual machine are additionally set in the server apparatus of the replication destination, the address mapping information is set in the operation-side switch of the replication destination so that only the external address is different from the replication source, and the logical configuration of the replication source is thereby automatically replicated in the replication destination. Thus, according to this embodiment, it is possible to eliminate the troubles required for the various complicated settings in the integrated system of the replication destination, and a test environment can be swiftly constructed in the integrated system of the replication destination.

### (2) Second Embodiment

The second embodiment differs from the first embodiment with respect to the point that the test environment, which was constructed in advance in the integrated system, is replicated in the same integrated system. The different points are now explained in detail with reference to the drawings.

### (2-1) Overall Configuration

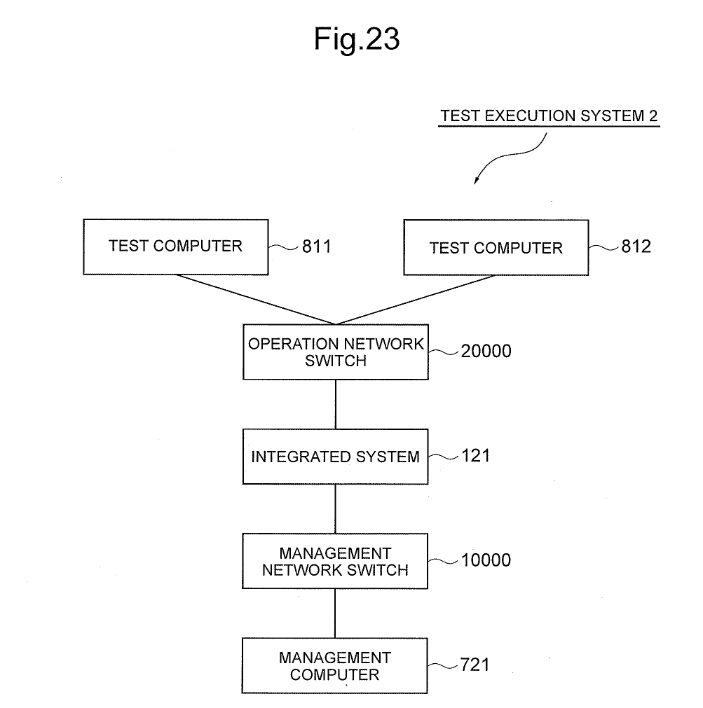

FIG. 23 shows the overall configuration of the test execution system 2 in the second embodiment. The test execution system 2 differs from the test execution system 1 in the first embodiment with respect to the point that one integrated system 121 is allocated and the replication SAN switch is not allocated.

### (2-2) Internal Configuration

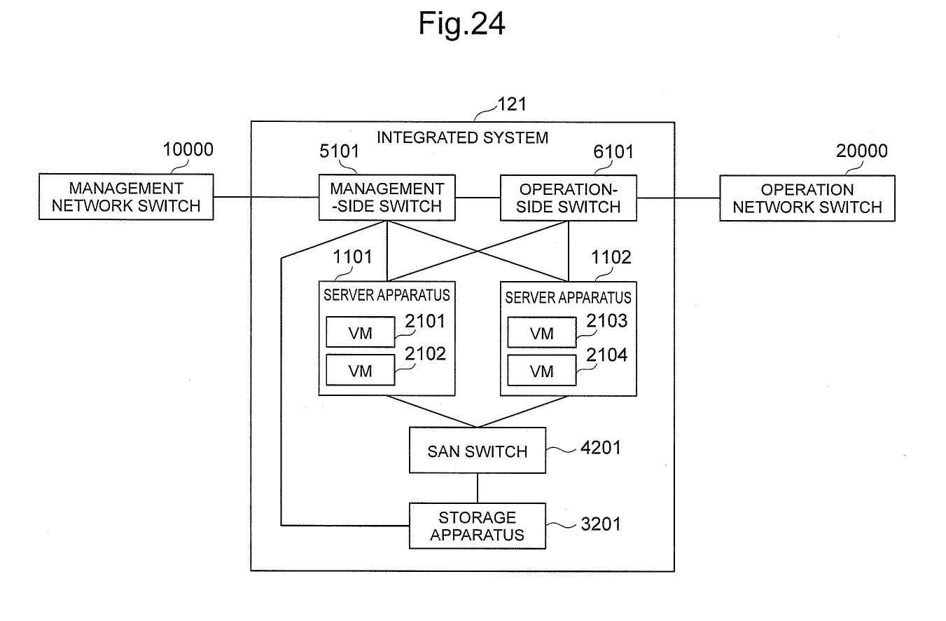

FIG. 24 shows the internal configuration of the integrated system 121. The integrated system 121 differs from the integrated system 111 in the first embodiment with respect to the point that the storage apparatus 3201 and the replication SAN switch are not connected since the replication SAN switch is not allocated in the test execution system 2 as described above.

Moreover, the operation-side switch 6201 differs from the operation-side switch 6101 in the first embodiment with respect to the point that it has a function of logically dividing the network, and setting an address mapping information 7158a (FIG. 20) and a communication control information 7158b (FIG. 21) to the respective networks.

Moreover, the SAN switch 4201 differs from the SAN switch 4101 in the first embodiment with respect to the point that it has a function of logically dividing the SAN, and using the logical switch that was divided as the replication SAN switch 30000 in the first embodiment.

Moreover, the storage apparatus 3201 differs from the storage apparatus 3101 in the first embodiment with respect to the point that it has a function of logically dividing the storage apparatus, and, in a test environment, the storage apparatus is divided logically so that the physical resources are divided equally in advance.

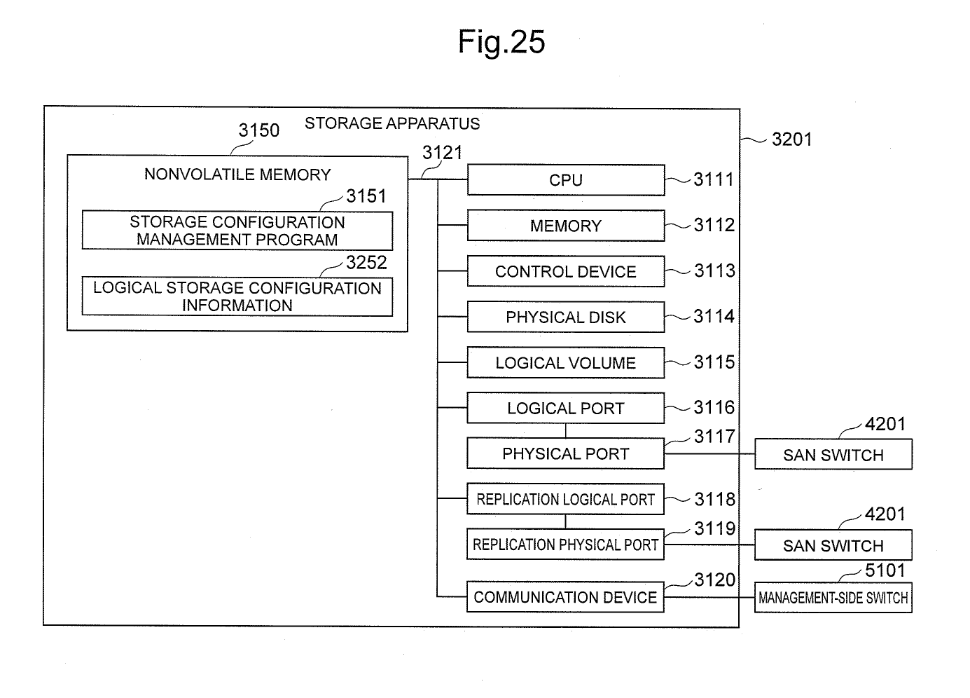

FIG. 25 shows the internal configuration of the storage apparatus 3201. The storage apparatus 3201 differs from the storage apparatus 3101 in the first embodiment with respect to the point that the replication physical port 3119 is connected to the SAN switch 4201 and the point that the logical storage configuration information 3252 is stored in the nonvolatile memory 3150.

The logical storage configuration information 3153 stores configuration information including the physical resources assigned to the logical storage apparatus created in the storage apparatus 3201, and the logical resources such as the logical volume, the logical port and the replication logical port configured from the physical resources. Note that information, in which the test environment identifying information is added to the logical storage configuration information 3153, is stored in the management computer 721 as the logical storage configuration information 7257.

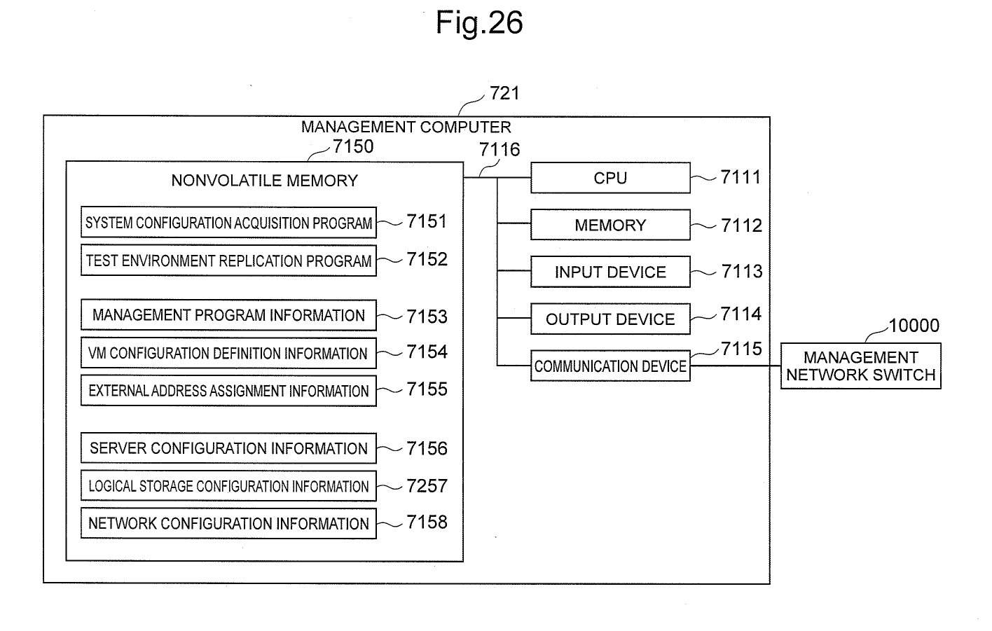

FIG. 26 shows the internal configuration of the management computer 721. The management computer 721 differs from the management computer 711 in the first embodiment with respect to the point that the logical storage configuration information 7257 is stored in the nonvolatile memory 7150.

The logical storage configuration information 7257 includes information in which the test environment identifying information is added to the logical storage configuration information 3153 acquired from the storage configuration management program 3151.

### (2-3) Details of Each Configuration

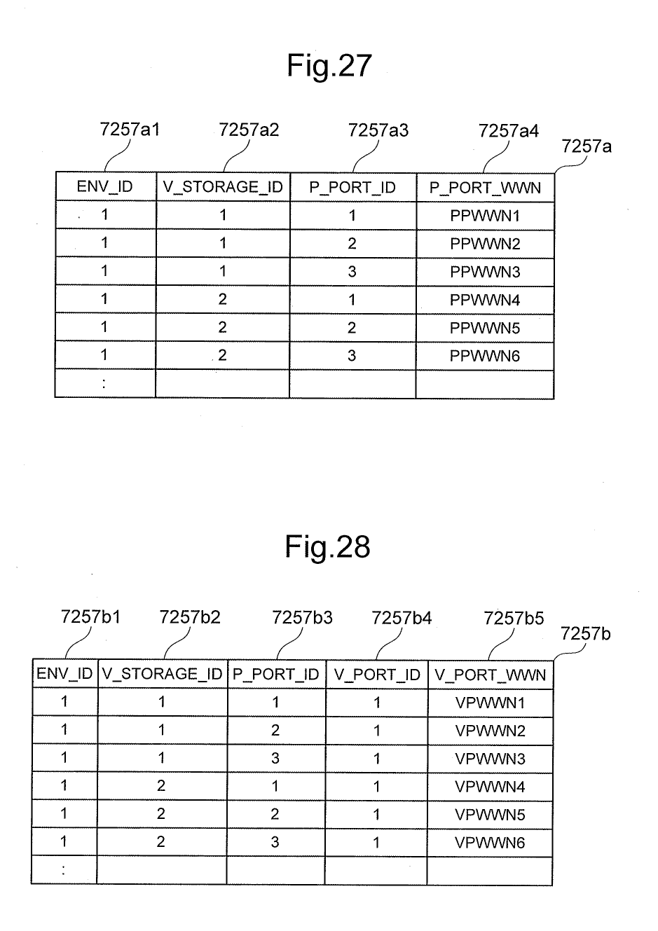

FIG. 27 shows the logical configuration of the physical port information 7257a included in the logical storage configuration information 7257. The physical port information 7257a differs from the physical port information 7157a (FIG. 16) in the first embodiment with respect to the point that it is configured by including a logical storage apparatus ID column 7257a2. The logical storage apparatus ID column 7257a2 stores identifying information for identifying a unique logical storage apparatus in the integrated system 121.

FIG. 28 shows the logical configuration of the logical port information 7257b included in the logical storage configuration information 7257. The logical port information 7257b differs from the logical port information 7157b (FIG. 17) in the first embodiment with respect to the point that it is configured by including a logical storage apparatus ID column 7257b2. The logical storage apparatus ID column 7257b2 stores identifying information for identifying a unique logical storage apparatus in the integrated system 121.

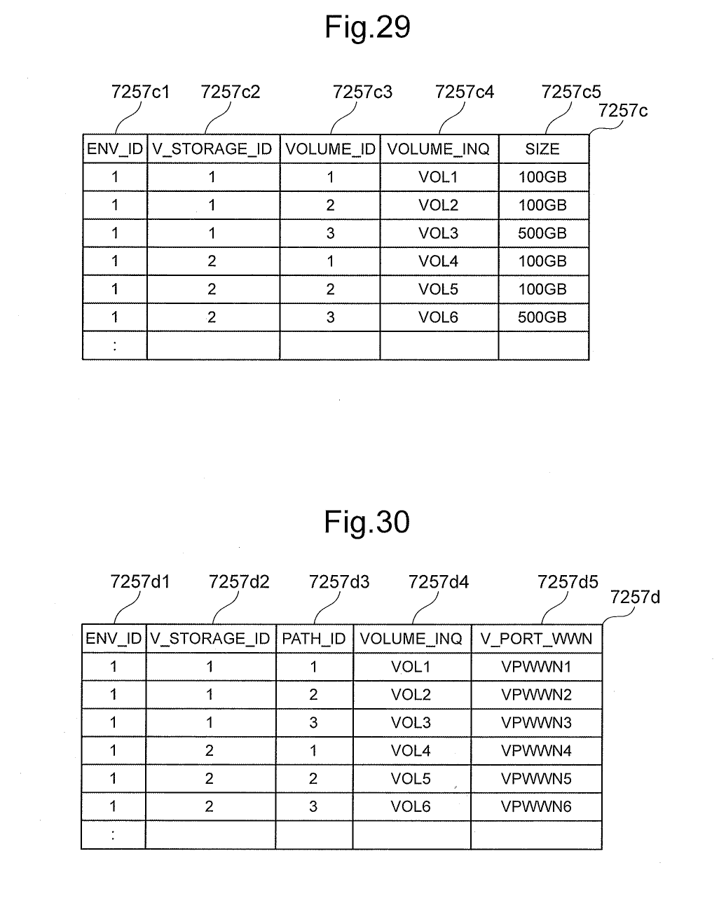

FIG. 29 shows the logical configuration of the logical volume information 7257c included in the logical storage configuration information 7257. The logical volume information 7257c differs from the logical volume information 7157c (FIG. 18) in the first embodiment with respect to the point that it is configured by including a logical storage apparatus ID column 7257c2. The logical storage apparatus ID column 7257c2 stores identifying information for identifying a unique logical storage apparatus in the integrated system 121.

FIG. 30 shows the logical configuration of the path information 7257d included in the logical storage configuration information 7257. The path information 7257d differs from the path information 7157d (FIG. 19) in the first embodiment with respect to the point that it is configured by including a logical storage apparatus ID column 7257d2. The logical storage apparatus ID column 7257d2 stores identifying information for identifying a unique logical storage apparatus in the integrated system 121.

Note that, in the second embodiment, since a test environment is replicated and constructed in one integrated system 121, the test environment identifying information in FIG. 27 to FIG. 30 is indicating as being fixed to “1” in all cases.

In the second embodiment, by using a logical storage apparatus ID in substitute for a storage apparatus ID upon executing the test environment construction processing (FIG. 22) in the first embodiment, a test environment that was constructed in advance in one integrated system 121 can be replicated in the same integrated system 121.

### (2-4) Effect of Second Embodiment

As described above, according to the second embodiment, among the plurality of integrations that are logically divided in one integrated system 121, a test environment is replicated from one logical integrated system, in which a test environment has been constructed in advance, to the logical integrated system of the replication destination, and the test environment is constructed in the logical integrated system of the replication destination. Thus, a test environment can be swiftly constructed without having to physically prepare an integrated system of the replication destination.

### (3) Third Embodiment

The third embodiment differs from the first embodiment with respect to the point that it is determined, for each logical volume of the replication source, whether the logical volume is to be replicated in the replication destination, and only the selected logical volume is replicated in the replication destination. The different points are now explained in detail with reference to the drawings.

### (3-1) Internal Configuration

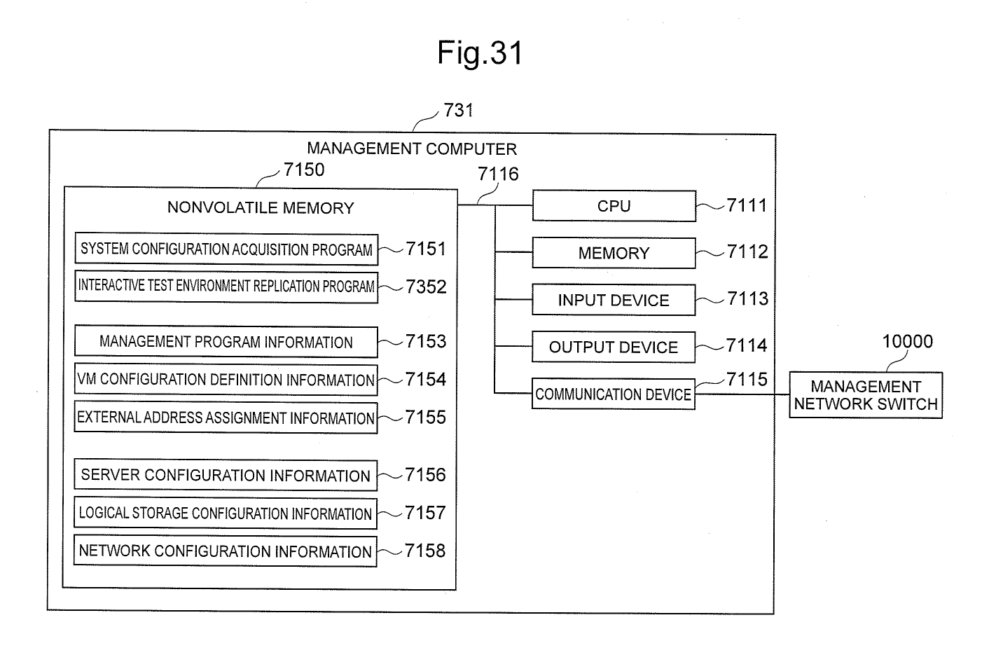

FIG. 31 shows the internal configuration of the management computer 731 in the third embodiment. The management computer 731 differs from the management computer 711 in the first embodiment with respect to the point that the interactive test environment replication program 7352 is stored in the nonvolatile memory 7150.

Unlike the test environment replication program 7152 in the first embodiment, the interactive test environment replication program 7352 does not replicate the data of all logical volumes in the integrated system 111, but rather replicates only the data of the logical volumes that were selected by the administrator.

### (3-2) Screen Configuration

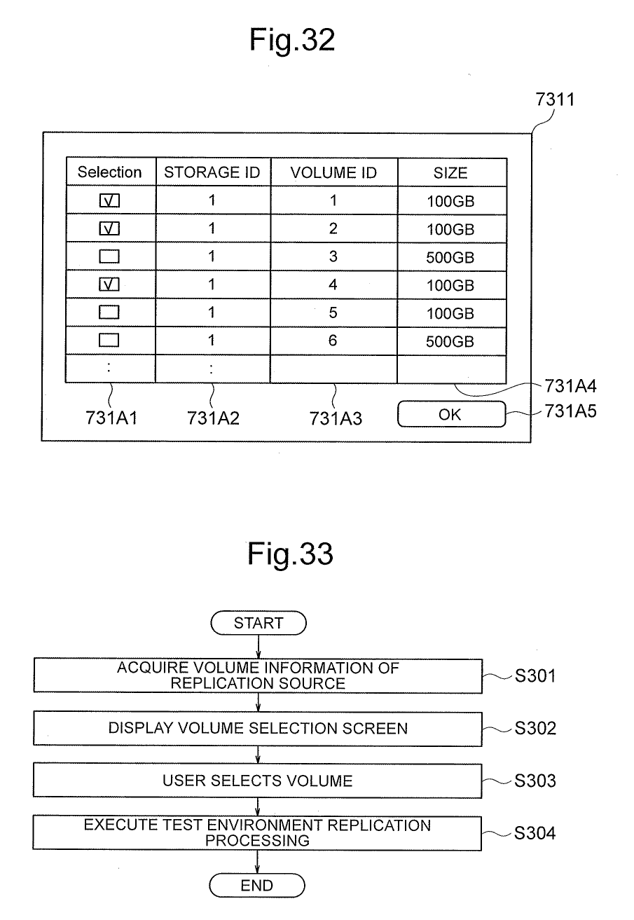

FIG. 32 shows the screen configuration of the volume selection screen 7311. The volume selection screen 7311 is a display screen to be displayed on the output device 7114 of the management computer 731, and is a display screen for selecting the logical volume to be replicated among the logical volumes of the replication source.

The volume selection screen 7311 is configured from a volume selection area 731A1, a storage apparatus ID area 731A2, a logical volume ID area 731A3, a volume size area 731A4 and an execution operation area 731A5.

The volume selection area 731A1 displays a selectable checkbox in the quantity of the logical volumes that are set in the replication source. The storage apparatus ID area 731A2 displays identifying information for identifying a unique storage apparatus in the integrated system of the replication source. The logical volume ID area 731A3 displays identifying information for identifying a unique logical volume in the integrated system of the replication source. The volume size area 731A4 displays the size of the logical volume.

Accordingly, the case of FIG. 32 shows that, for example, the logical volume of the uppermost entry has been selected as the logical volume to be replicated since a check has been placed in the uppermost checkbox in the volume selection area 731A1. Moreover, FIG. 32 also shows that this logical volume is set in the storage apparatus having a storage apparatus ID of “1”, the logical volume ID is “1”, and the volume size is “100 GB”.

### (3-3) Flowchart

FIG. 33 shows the processing routine of the test environment construction processing in the third embodiment. The test environment construction processing is executed based on the interactive test environment replication program 7352 and the CPU 7111 when the management computer 711 receives an operation from the administrator. For the sake of convenience of explanation, the processing substance is explained as the interactive test environment replication program 7352.

Foremost, the interactive test environment replication program 7352 refers to the logical volume information 7157c (FIG. 18), and acquires information of all logical volumes that are set in the integrated system in which the test environment identifying information is “1” (S301).

Subsequently, the interactive test environment replication program 7352 displays a volume selection screen 7311 (FIG. 32) for selecting the logical volume to be replicated among the logical volumes acquired in step 301 (S302).

Subsequently, the interactive test environment replication program 7352 receives a selection from the administrator in the volume selection screen 7311, and selects the logical volume to be replicated (S303).

Subsequently, the interactive test environment replication program 7352 executes the test environment construction processing of replicating a test environment from the replication source integrated system to the replication destination integrated system based on the selected logical volume (S304), and thereby ends this test environment construction processing.

Note that, with regard to the test environment construction processing to be executed here, steps S103 to S110 of the test environment construction processing (FIG. 22) in the first embodiment are executed only with the logical volume selected by the interactive test environment replication program 7352 in step S303 as the processing target.

### (3-4) Effect of Third Embodiment

As described above, according to the third embodiment, is it possible to replicate only the required logical volume in the replication destination. Thus, there is no need to replicate unwanted logical volumes in the replication destination, and the test environment can thereby be swiftly constructed.

### REFERENCE SIGNS LIST

111, 112, 121 Integrated system
1101, 1102 Server apparatus
1152 Server configuration management program
1153 Host configuration information
2101 to 2104 Virtual machine
2115 Logical host bus adapter
21161, 21162 Logical communication device
3101 Storage apparatus
3115 Logical volume
3116 Logical port
3117 Physical port
3118, 3119 Replication physical port
3151 Storage configuration management program
3152, 7157 Storage configuration information
3201 Storage apparatus
3252, 7257 Logical storage configuration information
6101, 6201 Operation-side switch
6114 External port
61151, 61152 Internal port
6151 Network configuration management program
6152, 7158 Network configuration information
711, 721, 731 Management computer
7151 System configuration acquisition program
7152 Test environment replication program
7153 Management program information
7154 VM configuration definition information
7155 External address assignment information
7156 Server configuration information
7352 Interactive test environment replication program

1. A test environment management apparatus that is connected to an integrated system of a replication source and an integrated system of a replication destination, respectively,
the test environment management apparatus comprising:
a storage unit that stores configuration information of a server apparatus, a storage apparatus and a network apparatus configuring the replication source integrated system and the replication destination integrated system, respectively, as configuration information of a replication source and configuration information of a replication destination; and
a test environment replication unit that replicates a test environment, which was constructed in the replication source integrated system, in the replication destination integrated system by referring to the configuration information of the replication source and the configuration information of the replication destination, wherein the test environment replication unit:
creates, in a storage apparatus of the replication destination, a logical volume having a configuration that is the same as a configuration of a logical volume allocated in a storage apparatus of the replication source,
assigns, to each logical volume, a replication port for connecting a logical volume of the replication source and a logical volume of the replication destination, sets the replication port to go online, and replicates data, which is stored in the replication source logical volume, in the replication destination logical volume,
cancels the assignment of the replication port by changing the setting of the replication port from online to offline, thereafter sets identifying information of the replication destination logical volume so that identifying information of the replication source logical volume and identifying information of the replication destination logical volume coincide,
creates, in the replication destination storage apparatus, a logical port having a configuration that is the same as a configuration of a logical port of the replication source, and assigns the created logical port of the replication destination to the replication destination logical volume,
creates, in a server apparatus of the replication destination, a logical configuration having a configuration that is the same as a logical configuration allocated in a server apparatus of the replication source, and
sets, in the replication destination integrated system, an internal address that is the same as an internal address set in the replication source integrated system and an external address that is different from an external address set in the replication source integrated system.

2. The test environment management apparatus according to claim 1, wherein
the configuration information of the replication source and the replication destination includes identifying information of a storage apparatus in which the replication source logical volume is allocated, quantity of the replication source logical volumes, and a volume size of the replication source logical volume, and
the test environment replication unit creates, in the replication destination storage apparatus, a logical volume in which the identifying information of the storage apparatus, the quantity of the logical volumes, and the volume size are respectively of the same configuration.

3. The test environment management apparatus according to claim 1, wherein
the configuration information of the replication source and the replication destination includes information indicating which physical ports among those allocated in the respective storage apparatuses of the replication source and the replication destination can be used as the replication port, and
the test environment replication unit selects, as the replication port, a physical port that can be used as the replication port and assigns that physical port to the respective logical volumes of the replication source and the replication destination, sets the replication port to go online, and replicates data, which is stored in the replication source logical volume, in the replication destination logical volume.

4. The test environment management apparatus according to claim 1, wherein
the configuration information of the replication source and the replication destination includes identifying information of the respective logical volumes of the replication source and the replication destination, and
the test environment replication unit sets the identifying information of the replication destination logical volume to be the identifying information that is the same as the identifying information of the replication source logical volume so that the identifying information of the replication source logical volume and the identifying information of the replication destination logical volume coincide.

5. The test environment management apparatus according to claim 1, wherein
the configuration information of the replication source and the replication destination includes identifying information of the replication source storage apparatus, identifying information of a physical port of the replication source, and identifying information of a logical port of the replication source, and
the test environment replication unit creates, in the replication destination storage apparatus, a logical port in which the identifying information of the storage apparatus, the identifying information of the physical port, and the identifying information of the logical port are respectively of the same configuration, and assigns the created logical port of the replication destination to the replication destination logical volume.

6. The test environment management apparatus according to claim 1, wherein
the configuration information of the replication source and the replication destination includes identifying information of a logical host bus adapter allocated in the replication source server apparatus, identifying information of a logical network interface card, and configuration information of a virtual machine, and
the test environment replication unit:
creates, in the replication destination server apparatus, a logical configuration having a configuration that is the same as a configuration of the logical host bus adapter, the logical network interface card and the virtual machine, and
permits communication from the outside to the replication destination integrated system.

7. The test environment management apparatus according to claim 1, further comprising:
a volume selection unit for selecting a logical volume to be replicated among the replication destination logical volumes, wherein
the test environment replication unit replicates only the logical volume selected by the volume selection unit in the replication destination, and replicates, in the replication destination, the configuration of the replication source storage apparatus, the server apparatus and the network apparatus corresponding to the logical volume replicated in the replication destination.

8. The test environment management apparatus according to claim 1, wherein
the configuration information of the replication source and the replication destination includes:
identifying information of a storage apparatus in which the replication source logical volume is allocated, quantity of the replication source logical volumes, and a volume size of the replication source logical volume,
information indicating which physical ports among those allocated in the respective storage apparatuses of the replication source and the replication destination can be used as the replication port,
identifying information of the respective logical volumes of the replication source and the replication destination,
identifying information of the replication source storage apparatus, identifying information of a physical port of the replication source, and identifying information of a logical port of the replication source, and
identifying information of a logical host bus adapter allocated in the replication source server apparatus, identifying information of a logical network interface card, and configuration information of a virtual machine, and
the test environment replication unit:
creates, in the replication destination storage apparatus, a logical volume in which the identifying information of the storage apparatus, the quantity of the logical volumes, and the volume size are respectively of the same configuration,
selects, as the replication port, a physical port that can be used as the replication port and assigns that physical port to the respective logical volumes of the replication source and the replication destination, sets the replication port to go online, and replicates data, which is stored in the replication source logical volume, in the replication destination logical volume,
sets the identifying information of the replication destination logical volume to be the identifying information that is the same as the identifying information of the replication source logical volume so that the identifying information of the replication source logical volume and the identifying information of the replication destination logical volume coincide,
creates, in the replication destination storage apparatus, a logical port in which the identifying information of the storage apparatus, the identifying information of the physical port, and the identifying information of the logical port are respectively of the same configuration, and assigns the created logical port of the replication destination to the replication destination logical volume,
creates, in the replication destination server apparatus, a logical configuration having a configuration that is the same as a configuration of the logical host bus adapter, the logical network interface card and the virtual machine, and
permits communication from the outside to the replication destination integrated system.

9. A test environment construction method of a test environment management apparatus that is connected to an integrated system of a replication source and an integrated system of a replication destination, respectively,
the test environment management apparatus comprising:
a storage unit that stores configuration information of a server apparatus, a storage apparatus and a network apparatus configuring the replication source integrated system and the replication destination integrated system, respectively, as configuration information of a replication source and configuration information of a replication destination; and
a test environment replication unit that replicates a test environment, which was constructed in the replication source integrated system, in the replication destination integrated system by referring to the configuration information of the replication source and the configuration information of the replication destination, wherein the test environment replication unit comprises:
a first step of creating, in a storage apparatus of the replication destination, a logical volume having a configuration that is the same as a configuration of a logical volume allocated in a storage apparatus of the replication source,
a second step of assigning, to each logical volume, a replication port for connecting a logical volume of the replication source and a logical volume of the replication destination, setting the replication port to go online, and replicating data, which is stored in the replication source logical volume, in the replication destination logical volume,
a third step of cancelling the assignment of the replication port by changing the setting of the replication port from online to offline, thereafter setting identifying information of the replication destination logical volume so that identifying information of the replication source logical volume and identifying information of the replication destination logical volume coincide,
a fourth step of creating, in the replication destination storage apparatus, a logical port having a configuration that is the same as a configuration of a logical port of the replication source, and assigning the created logical port of the replication destination to the replication destination logical volume,
a fifth step of creating, in a server apparatus of the replication destination, a logical configuration having a configuration that is the same as a logical configuration allocated in a server apparatus of the replication source, and
a sixth step of setting, in the replication destination integrated system, an internal address that is the same as an internal address set in the replication source integrated system and an external address that is different from an external address set in the replication source integrated system.

10. The test environment construction method according to claim 9, wherein
the configuration information of the replication source and the replication destination includes identifying information of a storage apparatus in which the replication source logical volume is allocated, quantity of the replication source logical volumes, and a volume size of the replication source logical volume, and
in the step 1, the test environment replication unit creates, in the replication destination storage apparatus, a logical volume in which the identifying information of the storage apparatus, the quantity of the logical volumes, and the volume size are respectively of the same configuration.

11. The test environment construction method according to claim 9, wherein
the configuration information of the replication source and the replication destination includes information indicating which physical ports among those allocated in the respective storage apparatuses of the replication source and the replication destination can be used as the replication port, and
in the step 2, the test environment replication unit selects, as the replication port, a physical port that can be used as the replication port and assigns that physical port to the respective logical volumes of the replication source and the replication destination, sets the replication port to go online, and replicates data, which is stored in the replication source logical volume, in the replication destination logical volume,

12. The test environment construction method according to claim 9, wherein
the configuration information of the replication source and the replication destination includes identifying information of the respective logical volumes of the replication source and the replication destination, and
in the step 3, the test environment replication unit sets the identifying information of the replication destination logical volume to be the identifying information that is the same as the identifying information of the replication source logical volume so that the identifying information of the replication source logical volume and the identifying information of the replication destination logical volume coincide.

13. The test environment construction method according to claim 9, wherein
the configuration information of the replication source and the replication destination includes identifying information of the replication source storage apparatus, identifying information of a physical port of the replication source, and identifying information of a logical port of the replication source, and
in the step 4, the test environment replication unit creates, in the replication destination storage apparatus, a logical port in which the identifying information of the storage apparatus, the identifying information of the physical port, and the identifying information of the logical port are respectively of the same configuration, and assigns the created logical port of the replication destination to the replication destination logical volume.

14. The test environment construction method according to claim 9, wherein
the configuration information of the replication source and the replication destination includes identifying information of a logical host bus adapter allocated in the replication source server apparatus, identifying information of a logical network interface card, and configuration information of a virtual machine, and
in the step 5, the test environment replication unit creates, in the replication destination server apparatus, a logical configuration having a configuration that is the same as a configuration of the logical host bus adapter, the logical network interface card and the virtual machine, and
in the step 6, the test environment replication unit permits communication from the outside to the replication destination integrated system.

15. The test environment construction method according to claim 9, wherein
the test environment management apparatus further comprises a volume selection unit for selecting a logical volume to be replicated among the replication destination logical volumes, and
the test environment construction method further comprises a step 7 of the test environment replication unit replicating only the logical volume selected by the volume selection unit in the replication destination, and replicating, in the replication destination, the configuration of the replication source storage apparatus, the server apparatus and the network apparatus corresponding to the logical volume replicated in the replication destination.
